(19) United States
(12) Patent Application Publication
(10) Pub. No.: US 2026/0353465 A1
(43) Pub. Date: Nov. 5, 2026

(54) TRIGGERED PRACH FOR CANDIDATE CELL

(71) Applicant: QUALCOMM Incorporated, San Diego, CA (US)

(72) Inventors: Fang YUAN, Beijing (CN); Yan ZHOU, San Diego, CA (US); Jelena DAMNJANOVIC, Del Mar, CA (US); Tao LUO, San Diego, CA (US)

(21) Appl. No.: 19/118,147

(22) PCT Filed: Nov. 7, 2022
(86) PCT No.: PCT/CN2022/130261

§ 371 Date: Apr. 3, 2025

(51) Int. Cl. H04W 74/0833; H04W 36/00; H04W 72/0453; H04W 72/23

(52) U.S. Cl. CPC H04W 74/0833; H04W 36/0072; H04W 72/0453; H04W 72/23

(57) ABSTRACT

Aspects relate to handover of a user equipment (UE) from a first cell (e.g., an SpCell) to a second cell (e.g., an SpCell). In some examples, Layer 1 signaling and/or Layer 2 signaling may be used to handover the UE from the first cell to the second cell. In some examples, the first cell may send a physical downlink control channel (PDCCH) order that triggers the UE to transmit a physical random access channel (PRACH) message to a candidate cell. In some examples, the first cell may send to the UE an indication specifies that the UE is to transmit only the PRACH message in response the PDCCH order. In some examples, the first cell sends at least one transmission parameter to the UE after the UE transmits the PRACH message to the second cell.

### TECHNICAL FIELD

The technology discussed below relates generally to wireless communication and, more particularly, to triggering the transmission of a physical random access channel message to a candidate cell.

### INTRODUCTION

Next-generation wireless communication systems (e.g., 5GS) may include a 5G core network and a 5G radio access network (RAN), such as a New Radio (NR)-RAN. The NR-RAN supports communication via one or more cells. For example, a wireless communication device such as a user equipment (UE) may access a first cell of a first base station (BS) such as a gNB and/or access a second cell of a second base station. A base station may schedule access to a cell to support access by multiple UEs. For example, a base station may allocate different resources (e.g., time domain and frequency domain resources) to be used by different UEs operating within the cell.

Different cells may serve a UE at different times. For example, a UE may initially be served by a first cell. Subsequently, an additional cell may be selected to serve the UE (e.g., to provide additional resources for serving the UE). Alternatively, or in addition, a cell that is serving the UE may be changed (switched out) whereby a different cell will serve the UE.

### BRIEF SUMMARY OF SOME EXAMPLES

The following presents a summary of one or more aspects of the present disclosure, in order to provide a basic understanding of such aspects. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in a form as a prelude to the more detailed description that is presented later.

In some examples, a user equipment may include a transceiver, and a processor coupled to the transceiver. The processor may be configured to receive, from a serving cell, a physical downlink control channel (PDCCH) order that triggers the user equipment to transmit a physical random access channel (PRACH) message to a candidate cell. The processor may also be configured to transmit the PRACH message to the candidate cell in response to the PDCCH order.

In some examples, a method for wireless communication at a user equipment is disclosed. The method may include receiving, from a serving cell, a physical downlink control channel (PDCCH) order that triggers the user equipment to transmit a physical random access channel (PRACH) message to a candidate cell. The method may also include transmitting the PRACH message to the candidate cell in response to the PDCCH order.

In some examples, a user equipment may include means for receiving, from a serving cell, a physical downlink control channel (PDCCH) order that triggers the user equipment to transmit a physical random access channel (PRACH) message to a candidate cell. The user equipment may also include means for transmitting the PRACH message to the candidate cell in response to the PDCCH order.

In some examples, a non-transitory computer-readable medium has stored therein instructions executable by one or more processors of a user equipment device to receive, from a serving cell, a physical downlink control channel (PDCCH) order that triggers the user equipment to transmit a physical random access channel (PRACH) message to a candidate cell. The computer-readable medium may also have stored therein instructions executable by one or more processors of the user equipment to transmit the PRACH message to the candidate cell in response to the PDCCH order.

In some examples, a network entity may include a transceiver, and a processor coupled to the transceiver. The processor may be configured to transmit a physical downlink control channel (PDCCH) order that triggers a user equipment to transmit a physical random access channel (PRACH) message to a candidate cell. The processor may also be configured to transmit a cell switch command to the user equipment via a layer 1 message or via a layer 2 message after transmitting the PDCCH order, the cell switch command indicating that the user equipment is to be handed-over to the candidate cell.

In some examples, a method for wireless communication at a network entity is disclosed. The method may include transmitting a physical downlink control channel (PDCCH) order that triggers a user equipment to transmit a physical random access channel (PRACH) message to a candidate cell. The method may also include transmitting a cell switch command to the user equipment via a layer 1 message or via a layer 2 message after transmitting the PDCCH order, the cell switch command indicating that the user equipment is to be handed-over to the candidate cell.

In some examples, a network entity may include means for transmitting a physical downlink control channel (PDCCH) order that triggers a user equipment to transmit a physical random access channel (PRACH) message to a candidate cell. The network entity may also include means for transmitting a cell switch command to the user equipment via a layer 1 message or via a layer 2 message after transmitting the PDCCH order, the cell switch command indicating that the user equipment is to be handed-over to the candidate cell.

In some examples, a non-transitory computer-readable medium has stored therein instructions executable by one or more processors of a network entity device to transmit a physical downlink control channel (PDCCH) order that triggers a user equipment to transmit a physical random access channel (PRACH) message to a candidate cell. The computer-readable medium may also have stored therein instructions executable by one or more processors of the network entity to transmit a cell switch command to the user equipment via a layer 1 message or via a layer 2 message after transmitting the PDCCH order, the cell switch command indicating that the user equipment is to be handed-over to the candidate cell.

These and other aspects of the disclosure will become more fully understood upon a review of the detailed description, which follows. Other aspects, features, and examples of the present disclosure will become apparent to those of ordinary skill in the art, upon reviewing the following description of specific, example aspects of the present disclosure in conjunction with the accompanying figures. While features of the present disclosure may be discussed relative to certain examples and figures below, all examples of the present disclosure can include one or more of the advantageous features discussed herein. In other words, while one or more examples may be discussed as having certain advantageous features, one or more of such features may also be used in accordance with the various examples of the disclosure discussed herein. In similar fashion, while example aspects may be discussed below as device, system, or method examples it should be understood that such example aspects can be implemented in various devices, systems, and methods.

### BRIEF DESCRIPTION OF THE DRAWINGS

FIG. 1 is a schematic illustration of a wireless communication system according to some aspects.

FIG. 2 is a conceptual illustration of an example of a radio access network according to some aspects.

FIG. 3 is a diagram providing a high-level illustration of one example of a configuration of a disaggregated base station according to some aspects.

FIG. 4 is a schematic illustration of wireless resources in an air interface utilizing orthogonal frequency divisional multiplexing (OFDM) according to some aspects.

FIG. 5A is a diagram illustrating an example of a frame structure of synchronization signals for use in a wireless communication network according to some aspects.

FIG. 5B is a diagram illustrating an example of a portion of a frame or subframe structure with various channels and associated messages for use in a wireless communication network according to some aspects.

FIG. 6 is a signaling diagram of an example of random access channel (RACH) related signaling according to some aspects.

FIG. 7 is a conceptual illustration of an example of wireless communication via multiple cells according to some aspects.

FIG. 8 is a conceptual illustration of an example of uplink and downlink timing according to some aspects.

FIG. 9 is a signaling diagram of an example of RACH-based handover signaling according to some aspects.

FIG. 10 is a signaling diagram of an example of RACH-less handover signaling according to some aspects.

FIG. 11 is a conceptual illustration of an example of a handover according to some aspects.

FIG. 12 is a diagram illustrating an example of differences between L3 mobility and L1/L2 mobility according to some aspects.

FIG. 13 is a signaling diagram of an example of RACH-less L1/L2 handover signaling according to some aspects.

FIG. 14 is a signaling diagram of an example of triggered physical random access channel (PRACH) signaling according to some aspects.

FIG. 15 is a diagram illustrating an example of a PRACH offset according to some aspects.

FIG. 16 is a signaling diagram of an example of transmission parameter signaling according to some aspects.

FIG. 17 is a block diagram conceptually illustrating an example of a hardware implementation for a user equipment employing a processing system according to some aspects.

FIG. 18 is a flow chart illustrating an example wireless communication method involving a triggered PRACH according to some aspects.

FIG. 19 is a flow chart illustrating an example wireless communication method involving the exchange of at least one transmission parameter according to some aspects.

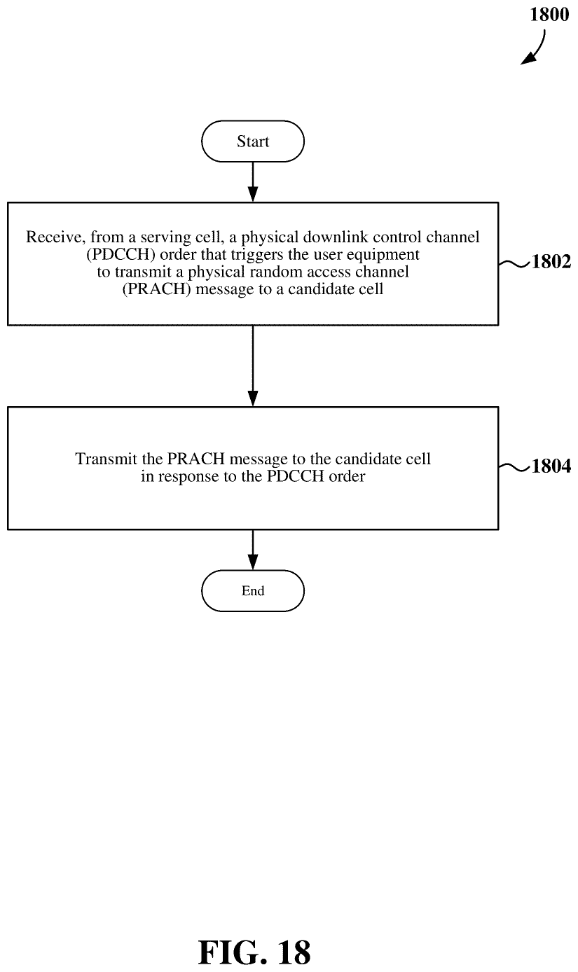

FIG. 18 is a block diagram conceptually illustrating an example of a hardware implementation for a network entity employing a processing system according to some aspects.

FIG. 21 is a flow chart illustrating an example wireless communication method involving a triggered PRACH according to some aspects.

FIG. 22 is a flow chart illustrating an example wireless communication method involving the exchange of at least one transmission parameter according to some aspects.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

While aspects and examples are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements. For example, aspects and/or uses may come about via integrated chip examples and other non-module-component based devices (e.g., end-user devices, vehicles, communication devices, computing devices, industrial equipment, retail/purchasing devices, medical devices, artificial intelligence-enabled (AI-enabled) devices, etc.). While some examples may or may not be specifically directed to use cases or applications, a wide assortment of applicability of described innovations may occur. Implementations may range a spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described examples. For example, transmission and reception of wireless signals necessarily includes a number of components for analog and digital purposes (e.g., hardware components including antenna, radio frequency (RF) chains, power amplifiers, modulators, buffer, processor(s), interleaver, adders/summers, etc.). It is intended that innovations described herein may be practiced in a wide variety of devices, chip-level components, systems, distributed arrangements, disaggregated arrangements (e.g., base station and/or UE), end-user devices, etc., of varying sizes, shapes, and constitution.

Various aspects of the disclosure relate to handover procedures. For example, a user equipment (UE) may be handed-over from a first cell (e.g., an SpCell) to a second cell (e.g., an SpCell). In some examples, Layer 1 (L1) signaling and/or Layer 2 (L2) signaling may be used to handover the UE from the first cell to the second cell. In some examples, the handover may omit a random access channel (RACH) procedure.

The disclosure relates in some aspects to a triggered physical random access channel (PRACH) transmission. For example, a serving cell may send a message to a UE that instructs the UE to transmit a PRACH message to a candidate cell. In some aspects, the message may indicate that the UE should not expect a response to the PRACH message.

The disclosure relates in some aspects to providing a UE with at least one transmission parameter after the UE transmits a PRACH message to a candidate cell. For example, the candidate cell may determine the at least one transmission parameter based on the PRACH message and transmit the at least one transmission parameter to the active serving cell. The active serving cell may then forward the at least one transmission parameter to the UE, which may then use the at least one transmission parameter to transmit an uplink transmission to the candidate cell.

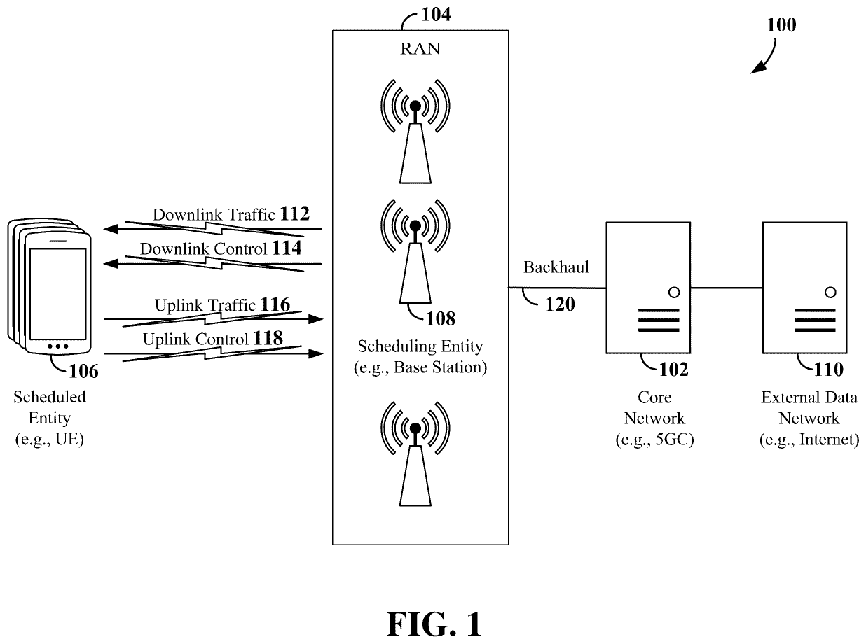

The various concepts presented throughout this disclosure may be implemented across a broad variety of telecommunication systems, network architectures, and communication standards. Referring now to FIG. 1, as an illustrative example without limitation, various aspects of the present disclosure are illustrated with reference to a wireless communication system 100. The wireless communication system 100 includes three interacting domains: a core network 102, a radio access network (RAN) 104, and a user equipment (UE) 106. By virtue of the wireless communication system 100, the UE 106 may be enabled to carry out data communication with an external data network 110, such as (but not limited to) the Internet.

The RAN 104 may implement any suitable wireless communication technology or technologies to provide radio access to the UE 106. As one example, the RAN 104 may operate according to 3rd Generation Partnership Project (3GPP) New Radio (NR) specifications, often referred to as 5G. As another example, the RAN 104 may operate under a hybrid of 5G NR and Evolved Universal Terrestrial Radio Access Network (eUTRAN) standards, often referred to as Long-Term Evolution (LTE). The 3GPP refers to this hybrid RAN as a next-generation RAN, or NG-RAN. In another example, the RAN 104 may operate according to both the LTE and 5G NR standards. Of course, many other examples may be utilized within the scope of the present disclosure.

As illustrated, the RAN 104 includes a plurality of base stations 108. Broadly, a base station is a network element in a radio access network responsible for radio transmission and reception in one or more cells to or from a UE. In different technologies, standards, or contexts, a base station may variously be referred to by those skilled in the art as a base transceiver station (BTS), a radio base station, a radio transceiver, a transceiver function, a basic service set (BSS), an extended service set (ESS), an access point (AP), a Node B (NB), an eNode B (eNB), a gNode B (gNB), a transmission and reception point (TRP), or some other suitable terminology. In some examples, a base station may include two or more TRPs that may be collocated or non-collocated. Each TRP may communicate on the same or different carrier frequency within the same or different frequency band. In examples where the RAN 104 operates according to both the LTE and 5G NR standards, one of the base stations 108 may be an LTE base station, while another base station may be a 5G NR base station.

The radio access network 104 is further illustrated supporting wireless communication for multiple mobile apparatuses. A mobile apparatus may be referred to as user equipment (UE) 106 in 3GPP standards, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. A UE 106 may be an apparatus that provides a user with access to network services. In examples where the RAN 104 operates according to both the LTE and 5G NR standards, the UE 106 may be an Evolved-Universal Terrestrial Radio Access Network-New Radio dual connectivity (EN-DC) UE that is capable of simultaneously connecting to an LTE base station and an NR base station to receive data packets from both the LTE base station and the NR base station.

Within the present document, a mobile apparatus need not necessarily have a capability to move, and may be stationary. The term mobile apparatus or mobile device broadly refers to a diverse array of devices and technologies. UEs may include a number of hardware structural components sized, shaped, and arranged to help in communication; such components can include antennas, antenna arrays, RF chains, amplifiers, one or more processors, etc., electrically coupled to each other. For example, some non-limiting examples of a mobile apparatus include a mobile, a cellular (cell) phone, a smart phone, a session initiation protocol (SIP) phone, a laptop, a personal computer (PC), a notebook, a netbook, a smartbook, a tablet, a personal digital assistant (PDA), and a broad array of embedded systems, e.g., corresponding to an Internet of Things (IOT).

A mobile apparatus may additionally be an automotive or other transportation vehicle, a remote sensor or actuator, a robot or robotics device, a satellite radio, a global positioning system (GPS) device, an object tracking device, a drone, a multi-copter, a quad-copter, a remote control device, a consumer and/or wearable device, such as eyewear, a wearable camera, a virtual reality device, a smart watch, a health or fitness tracker, a digital audio player (e.g., MP3 player), a camera, a game console, etc. A mobile apparatus may additionally be a digital home or smart home device such as a home audio, video, and/or multimedia device, an appliance, a vending machine, intelligent lighting, a home security system, a smart meter, etc. A mobile apparatus may additionally be a smart energy device, a security device, a solar panel or solar array, a municipal infrastructure device controlling electric power (e.g., a smart grid), lighting, water, etc., an industrial automation and enterprise device, a logistics controller, agricultural equipment, etc. Still further, a mobile apparatus may provide for connected medicine or telemedicine support, i.e., health care at a distance. Telehealth devices may include telehealth monitoring devices and telehealth administration devices, whose communication may be given preferential treatment or prioritized access over other types of information, e.g., in terms of prioritized access for transport of critical service data, and/or relevant QoS for transport of critical service data.

Wireless communication between a RAN 104 and a UE 106 may be described as utilizing an air interface. Transmissions over the air interface from a base station (e.g., base station 108) to one or more UEs (e.g., UE 106) may be referred to as downlink (DL) transmission. In some examples, the term downlink may refer to a point-to-multipoint transmission originating at a base station (e.g., base station 108). Another way to describe this point-to-multipoint transmission scheme may be to use the term broadcast channel multiplexing. Transmissions from a UE (e.g., UE 106) to a base station (e.g., base station 108) may be referred to as uplink (UL) transmissions. In some examples, the term uplink may refer to a point-to-point transmission originating at a UE (e.g., UE 106).

In some examples, access to the air interface may be scheduled, wherein a scheduling entity (e.g., a base station 108) of some other type of network entity allocates resources for communication among some or all devices and equipment within its service area or cell. Within the present disclosure, as discussed further below, the scheduling entity may be responsible for scheduling, assigning, reconfiguring, and releasing resources for one or more scheduled entities (e.g., UEs). That is, for scheduled communication, a plurality of UEs 106, which may be scheduled entities, may utilize resources allocated by a scheduling entity (e.g., a base station 108).

Base stations 108 are not the only entities that may function as scheduling entities. That is, in some examples, a UE may function as a scheduling entity, scheduling resources for one or more scheduled entities (e.g., one or more other UEs). For example, UEs may communicate with other UEs in a peer-to-peer or device-to-device fashion and/or in a relay configuration.

As illustrated in FIG. 1, a scheduling entity (e.g., a base station 108) may broadcast downlink traffic 112 to one or more scheduled entities (e.g., a UE 106). Broadly, the scheduling entity is a node or device responsible for scheduling traffic in a wireless communication network, including the downlink traffic 112 and, in some examples, uplink traffic 116 and/or uplink control information 118 from one or more scheduled entities to the scheduling entity. On the other hand, the scheduled entity is a node or device that receives downlink control information 114, including but not limited to scheduling information (e.g., a grant), synchronization or timing information, or other control information from another entity in the wireless communication network such as the scheduling entity.

In addition, the uplink control information 118, downlink control information 114, downlink traffic 112, and/or uplink traffic 116 may be time-divided into frames, subframes, slots, and/or symbols. As used herein, a symbol may refer to a unit of time that, in an orthogonal frequency division multiplexed (OFDM) waveform, carries one resource element (RE) per sub-carrier. A slot may carry 7 or 14 OFDM symbols in some examples. A subframe may refer to a duration of 1 millisecond (ms). Multiple subframes or slots may be grouped together to form a single frame or radio frame. Within the present disclosure, a frame may refer to a predetermined duration (e.g., 10 ms) for wireless transmissions, with each frame consisting of, for example, 10 subframes of 1 ms each. Of course, these definitions are not required, and any suitable scheme for organizing waveforms may be utilized, and various time divisions of the waveform may have any suitable duration.

In general, base stations 108 may include a backhaul interface for communication with a backhaul 120 of the wireless communication system. The backhaul 120 may provide a link between a base station 108 and the core network 102. Further, in some examples, a backhaul network may provide interconnection between the respective base stations 108. Various types of backhaul interfaces may be employed, such as a direct physical connection, a virtual network, or the like using any suitable transport network.

The core network 102 may be a part of the wireless communication system 100, and may be independent of the radio access technology used in the RAN 104. In some examples, the core network 102 may be configured according to 5G standards (e.g., 5GC). In other examples, the core network 102 may be configured according to a 4G evolved packet core (EPC), or any other suitable standard or configuration.

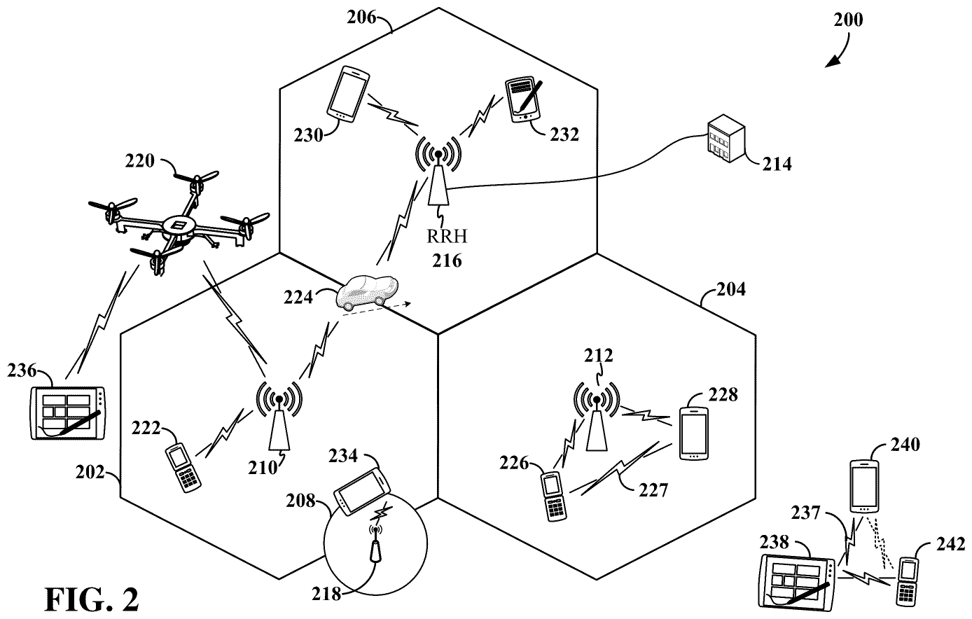

Referring now to FIG. 2, by way of example and without limitation, a schematic illustration of a radio access network (RAN) 200 is provided. In some examples, the RAN 200 may be the same as the RAN 104 described above and illustrated in FIG. 1.

The geographic area covered by the RAN 200 may be divided into cellular regions (cells) that can be uniquely identified by a user equipment (UE) based on an identification broadcasted from one access point or base station. FIG. 2 illustrates cells 202, 204, 206, and 208, each of which may include one or more sectors (not shown). A sector is a sub-area of a cell. All sectors within one cell are served by the same base station. A radio link within a sector can be identified by a single logical identification belonging to that sector. In a cell that is divided into sectors, the multiple sectors within a cell can be formed by groups of antennas with each antenna responsible for communication with UEs in a portion of the cell.

Various base station arrangements can be utilized. For example, in FIG. 2, two base stations 210 and 212 are shown in cells 202 and 204; and a base station 214 is shown controlling a remote radio head (RRH) 216 in cell 206. That is, a base station can have an integrated antenna or can be connected to an antenna or RRH by feeder cables. In the illustrated example, the cells 202, 204, and 206 may be referred to as macrocells, as the base stations 210, 212, and 214 support cells having a large size. Further, a base station 218 is shown in the cell 208, which may overlap with one or more macrocells. In this example, the cell 208 may be referred to as a small cell (e.g., a microcell, picocell, femtocell, home base station, home Node B, home eNode B, etc.), as the base station 218 supports a cell having a relatively small size. Cell sizing can be done according to system design as well as component constraints.

It is to be understood that the RAN 200 may include any number of wireless base stations and cells. Further, a relay node may be deployed to extend the size or coverage area of a given cell. The base stations 210, 212, 214, 218 provide wireless access points to a core network for any number of mobile apparatuses. In some examples, the base stations 210, 212, 214, and/or 218 may be the same as the base station/scheduling entity described above and illustrated in FIG. 1.

FIG. 2 further includes an unmanned aerial vehicle (UAV) 220, which may be a drone or quadcopter. The UAV 220 may be configured to function as a base station, or more specifically as a mobile base station. That is, in some examples, a cell may not necessarily be stationary, and the geographic area of the cell may move according to the location of a mobile base station, such as the UAV 220.

Within the RAN 200, the cells may include UEs that may be in communication with one or more sectors of each cell. Further, each base station 210, 212, 214, and 218 may be configured to provide an access point to a core network 102 (see FIG. 1) for all the UEs in the respective cells. For example, UEs 222 and 224 may be in communication with base station 210; UEs 226 and 228 may be in communication with base station 212; UEs 230 and 232 may be in communication with base station 214 by way of RRH 216; and UE 234 may be in communication with base station 218. In some examples, the UEs 222, 224, 226, 228, 230, 232, 234, 236, 238, 240, and/or 242 may be the same as the UE/scheduled entity described above and illustrated in FIG. 1. In some examples, the UAV 220 (e.g., the quadcopter) can be a mobile network node and may be configured to function as a UE. For example, the UAV 220 may operate within cell 202 by communicating with base station 210.

In a further aspect of the RAN 200, sidelink signals may be used between UEs without necessarily relying on scheduling or control information from a base station. Sidelink communication may be utilized, for example, in a device-to-device (D2D) network, peer-to-peer (P2P) network, vehicle-to-vehicle (V2V) network, vehicle-to-everything (V2X) network, and/or other suitable sidelink network. For example, two or more UEs (e.g., UEs 238, 240, and 242) may communicate with each other using sidelink signals 237 without relaying that communication through a base station. In some examples, the UEs 238, 240, and 242 may each function as a scheduling entity or transmitting sidelink device and/or a scheduled entity or a receiving sidelink device to schedule resources and communicate sidelink signals 237 therebetween without relying on scheduling or control information from a base station. In other examples, two or more UEs (e.g., UEs 226 and 228) within the coverage area of a base station (e.g., base station 212) may also communicate sidelink signals 227 over a direct link (sidelink) without conveying that communication through the base station 212. In this example, the base station 212 may allocate resources to the UEs 226 and 228 for the sidelink communication.

In the RAN 200, the ability for a UE to communicate while moving, independent of its location, is referred to as mobility. The various physical channels between the UE and the radio access network are generally set up, maintained, and released under the control of an access and mobility management function (AMF, not illustrated, part of the core network 102 in FIG. 1), which may include a security context management function (SCMF) that manages the security context for both the control plane and the user plane functionality, and a security anchor function (SEAF) that performs authentication.

A RAN 200 may utilize DL-based mobility or UL-based mobility to enable mobility and handovers (i.e., the transfer of a UE's connection from one radio channel to another). In a network configured for DL-based mobility, during a call with a scheduling entity, or at any other time, a UE may monitor various parameters of the signal from its serving cell as well as various parameters of neighboring cells. Depending on the quality of these parameters, the UE may maintain communication with one or more of the neighboring cells. During this time, if the UE moves from one cell to another, or if signal quality from a neighboring cell exceeds that from the serving cell for a given amount of time, the UE may undertake a handoff or handover from the serving cell to the neighboring (target) cell. For example, UE 224 (illustrated as a vehicle, although any suitable form of UE may be used) may move from the geographic area corresponding to its serving cell (e.g., the cell 202) to the geographic area corresponding to a neighbor cell (e.g., the cell 206). When the signal strength or quality from the neighbor cell exceeds that of the serving cell for a given amount of time, the UE 224 may transmit a reporting message to its serving base station (e.g., the base station 210) indicating this condition. In response, the UE 224 may receive a handover command, and the UE may undergo a handover to the cell 206.

In a network configured for UL-based mobility, UL reference signals from each UE may be utilized by the network to select a serving cell for each UE. In some examples, the base stations 210, 212, and 214/216 may broadcast unified synchronization signals (e.g., unified Primary Synchronization Signals (PSSs), unified Secondary Synchronization Signals (SSSs) and unified Physical Broadcast Channels (PBCH)). The UEs 222, 224, 226, 228, 230, and 232 may receive the unified synchronization signals, derive the carrier frequency and slot timing from the synchronization signals, and in response to deriving timing, transmit an uplink pilot or reference signal. The uplink pilot signal transmitted by a UE (e.g., UE 224) may be concurrently received by two or more cells (e.g., base stations 210 and 214/216) within the RAN 200. Each of the cells may measure a strength of the pilot signal, and the radio access network (e.g., one or more of the base stations 210 and 214/216 and/or a central node within the core network) may determine a serving cell for the UE 224. As the UE 224 moves through the RAN 200, the network may continue to monitor the uplink pilot signal transmitted by the UE 224. When the signal strength or quality of the pilot signal measured by a neighboring cell exceeds that of the signal strength or quality measured by the serving cell, the RAN 200 may handover the UE 224 from the serving cell to the neighboring cell, with or without informing the UE 224.

Although the synchronization signal transmitted by the base stations 210, 212, and 214/216 may be unified, the synchronization signal may not identify a particular cell, but rather may identify a zone of multiple cells operating on the same frequency and/or with the same timing. The use of zones in 5G networks or other next generation communication networks enables the uplink-based mobility framework and improves the efficiency of both the UE and the network, since the number of mobility messages that need to be exchanged between the UE and the network may be reduced.

In various implementations, the air interface in the RAN 200 may utilize licensed spectrum, unlicensed spectrum, or shared spectrum. Licensed spectrum provides for exclusive use of a portion of the spectrum, generally by virtue of a mobile network operator purchasing a license from a government regulatory body. Unlicensed spectrum provides for shared use of a portion of the spectrum without the need for a government-granted license. While compliance with some technical rules is generally still required to access unlicensed spectrum, generally, any operator or device may gain access. Shared spectrum may fall between licensed and unlicensed spectrum, wherein technical rules or limitations may be required to access the spectrum, but the spectrum may still be shared by multiple operators and/or multiple radio access technologies (RATs). For example, the holder of a license for a portion of licensed spectrum may provide licensed shared access (LSA) to share that spectrum with other parties, e.g., with suitable licensee-determined conditions to gain access.

The air interface in the RAN 200 may utilize one or more multiplexing and multiple access algorithms to enable simultaneous communication of the various devices. For example, 5G NR specifications provide multiple access for UL transmissions from UEs 222 and 224 to base station 210, and for multiplexing for DL transmissions from base station 210 to one or more UEs 222 and 224, utilizing orthogonal frequency division multiplexing (OFDM) with a cyclic prefix (CP). In addition, for UL transmissions, 5G NR specifications provide support for discrete Fourier transform-spread-OFDM (DFT-s-OFDM) with a CP (also referred to as single-carrier FDMA (SC-FDMA)). However, within the scope of the present disclosure, multiplexing and multiple access are not limited to the above schemes, and may be provided utilizing time division multiple access (TDMA), code division multiple access (CDMA), frequency division multiple access (FDMA), sparse code multiple access (SCMA), resource spread multiple access (RSMA), or other suitable multiple access schemes. Further, multiplexing DL transmissions from the base station 210 to UEs 222 and 224 may be provided utilizing time division multiplexing (TDM), code division multiplexing (CDM), frequency division multiplexing (FDM), orthogonal frequency division multiplexing (OFDM), sparse code multiplexing (SCM), or other suitable multiplexing schemes.

The air interface in the RAN 200 may further utilize one or more duplexing algorithms. Duplex refers to a point-to-point communication link where both endpoints can communicate with one another in both directions. Full-duplex means both endpoints can simultaneously communicate with one another. Half-duplex means only one endpoint can send information to the other at a time. Half-duplex emulation is frequently implemented for wireless links utilizing time division duplex (TDD). In TDD, transmissions in different directions on a given channel are separated from one another using time division multiplexing. That is, at some times the channel is dedicated for transmissions in one direction, while at other times the channel is dedicated for transmissions in the other direction, where the direction may change very rapidly, e.g., several times per slot. In a wireless link, a full-duplex channel generally relies on physical isolation of a transmitter and receiver, and suitable interference cancelation technologies. Full-duplex emulation is frequently implemented for wireless links by utilizing frequency division duplex (FDD) or spatial division duplex (SDD). In FDD, transmissions in different directions operate at different carrier frequencies. In SDD, transmissions in different directions on a given channel are separate from one another using spatial division multiplexing (SDM). In other examples, full-duplex communication may be implemented within unpaired spectrum (e.g., within a single carrier bandwidth), where transmissions in different directions occur within different sub-bands of the carrier bandwidth. This type of full-duplex communication may be referred to as sub-band full-duplex (SBFD), cross-division duplex (xDD), or flexible duplex.

Deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CUS, the DUs, and the RUs also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

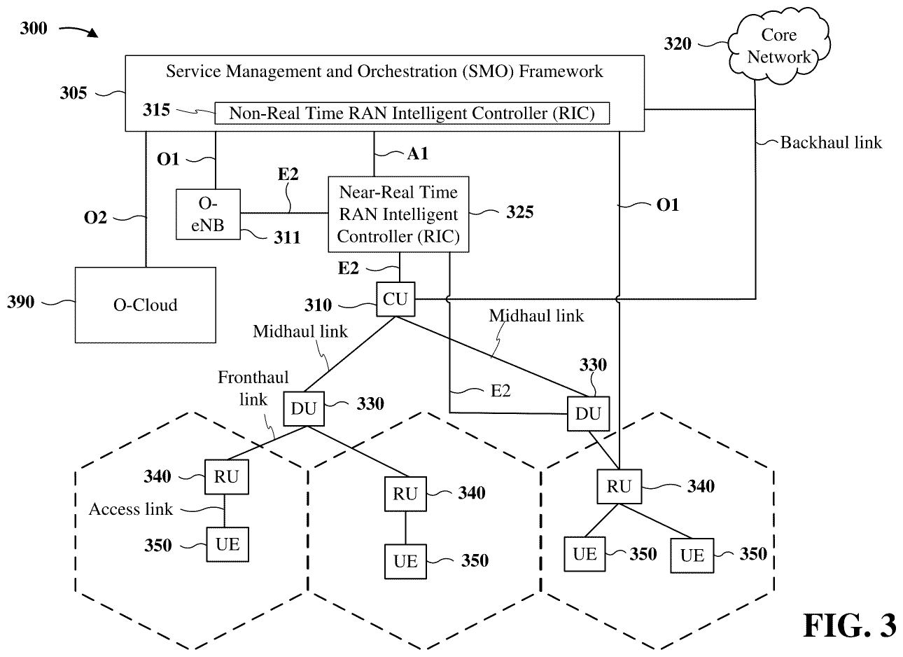

FIG. 3 shows a diagram illustrating an example disaggregated base station 300 architecture. The disaggregated base station 300 architecture may include one or more central units (CUs) 310 that can communicate directly with a core network 320 via a backhaul link, or indirectly with the core network 320 through one or more disaggregated base station units (such as a Near-Real Time (Near-RT) RAN Intelligent Controller (RIC) 325 via an E2 link, or a Non-Real Time (Non-RT) RIC 315 associated with a Service Management and Orchestration (SMO) Framework 305, or both). A CU 310 may communicate with one or more distributed units (DUs) 330 via respective midhaul links, such as an F1 interface. The DUs 330 may communicate with one or more radio units (RUS) 340 via respective fronthaul links. The RUs 340 may communicate with respective UEs 350 via one or more radio frequency (RF) access links. In some implementations, the UE 350 may be simultaneously served by multiple RUs 340.

Each of the units, i.e., the CUS 310, the DUs 330, the RUs 340, as well as the Near-RT RICs 325, the Non-RT RICs 315 and the SMO Framework 305, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (i.e., Central Unit-User Plane (CU-UP)), control plane functionality (i.e., Central Unit-Control Plane (CU-CP)), or a combination thereof. In some implementations, the CU 310 can be logically split into one or more CU-UP units and one or more CU-CP units. The CU-UP unit can communicate bidirectionally with the CU-CP unit via an interface, such as the El interface when implemented in an O-RAN configuration. The CU 310 can be implemented to communicate with the distributed unit (DU) 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 330 may further host one or more low PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 can be implemented to handle over the air (OTA) communication with one or more UEs 350. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (such as an Ol interface). For virtualized network elements, the SMO Framework 305 may be configured to interact with a cloud computing platform (such as an open cloud (O-Cloud) 390) to perform network element life cycle management (such as to instantiate virtualized network elements) via a cloud computing platform interface (such as an O2 interface). Such virtualized network elements can include, but are not limited to, CUs 310, DUs 330, RUs 340 and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an Al interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via O1) or via creation of RAN management policies (such as Al policies).

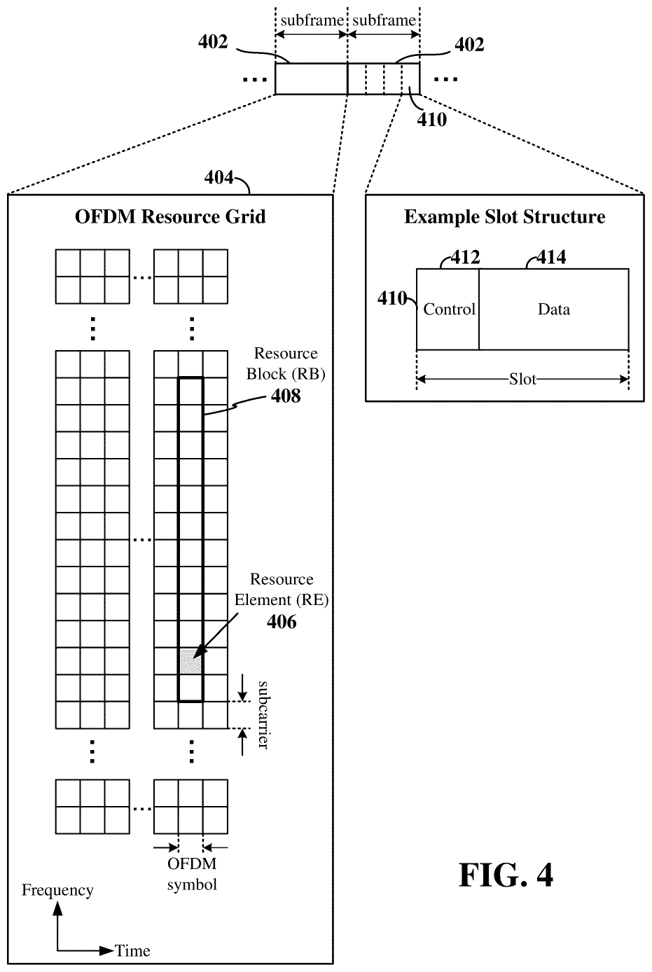

Various aspects of the present disclosure will be described with reference to an OFDM waveform, an example of which is schematically illustrated in FIG. 4. It should be understood by those of ordinary skill in the art that the various aspects of the present disclosure may be applied to an SC-FDMA waveform in substantially the same way as described herein below. That is, while some examples of the present disclosure may focus on an OFDM link for clarity, it should be understood that the same principles may be applied as well to SC-FDMA waveforms.

Referring now to FIG. 4, an expanded view of an example subframe 402 is illustrated, showing an OFDM resource grid. However, as those skilled in the art will readily appreciate, the physical (PHY) layer transmission structure for any particular application may vary from the example described here, depending on any number of factors. Here, time is in the horizontal direction with units of OFDM symbols; and frequency is in the vertical direction with units of subcarriers of the carrier.

The resource grid 404 may be used to schematically represent time-frequency resources for a given antenna port. In some examples, an antenna port is a logical entity used to map data streams to one or more antennas. Each antenna port may be associated with a reference signal (e.g., which may allow a receiver to distinguish data streams associated with the different antenna ports in a received transmission). An antenna port may be defined such that the channel over which a symbol on the antenna port is conveyed can be inferred from the channel over which another symbol on the same antenna port is conveyed. Thus, a given antenna port may represent a specific channel model associated with a particular reference signal. In some examples, a given antenna port and sub-carrier spacing (SCS) may be associated with a corresponding resource grid (including REs as discussed above). Here, modulated data symbols from multiple-input-multiple-output (MIMO) layers may be combined and re-distributed to each of the antenna ports, then precoding is applied, and the precoded data symbols are applied to corresponding REs for OFDM signal generation and transmission via one or more physical antenna elements. In some examples, the mapping of an antenna port to a physical antenna may be based on beamforming (e.g., a signal may be transmitted on certain antenna ports to form a desired beam). Thus, a given antenna port may correspond to a particular set of beamforming parameters (e.g., signal phases and/or amplitudes).

In a MIMO implementation with multiple antenna ports available, a corresponding multiple number of resource grids 404 may be available for communication. The resource grid 404 is divided into multiple resource elements (REs) 406. An RE, which is 1 subcarrier×1 symbol, is the smallest discrete part of the time-frequency grid, and contains a single complex value representing data from a physical channel or signal. Depending on the modulation utilized in a particular implementation, each RE may represent one or more bits of information. In some examples, a block of REs may be referred to as a physical resource block (PRB) or more simply a resource block (RB) 408, which contains any suitable number of consecutive subcarriers in the frequency domain. In one example, an RB may include 12 subcarriers, a number independent of the numerology used. In some examples, depending on the numerology, an RB may include any suitable number of consecutive OFDM symbols in the time domain. Within the present disclosure, it is assumed that a single RB such as the RB 408 entirely corresponds to a single direction of communication (either transmission or reception for a given device).

A set of continuous or discontinuous resource blocks may be referred to herein as a Resource Block Group (RBG), sub-band, or bandwidth part (BWP). A set of sub-bands or BWPs may span the entire bandwidth. Scheduling of scheduled entities (e.g., UEs) for downlink, uplink, or sidelink transmissions typically involves scheduling one or more resource elements 406 within one or more sub-bands or bandwidth parts (BWPs). Thus, a UE generally utilizes only a subset of the resource grid 404. In some examples, an RB may be the smallest unit of resources that can be allocated to a UE. Thus, the more RBs scheduled for a UE, and the higher the modulation scheme chosen for the air interface, the higher the data rate for the UE. The RBs may be scheduled by a scheduling entity, such as a base station (e.g., gNB, eNB, etc.), or may be self-scheduled by a UE implementing D2D sidelink communication.

In this illustration, the RB 408 is shown as occupying less than the entire bandwidth of the subframe 402, with some subcarriers illustrated above and below the RB 408. In a given implementation, the subframe 402 may have a bandwidth corresponding to any number of one or more RBs 408. Further, in this illustration, the RB 408 is shown as occupying less than the entire duration of the subframe 402, although this is merely one possible example.

Each 1 ms subframe 402 may consist of one or multiple adjacent slots. In the example shown in FIG. 4, one subframe 402 includes four slots 410, as an illustrative example. In some examples, a slot may be defined according to a specified number of OFDM symbols with a given cyclic prefix (CP) length. For example, a slot may include 7 or 14 OFDM symbols with a nominal CP. Additional examples may include mini-slots, sometimes referred to as shortened transmission time intervals (TTIs), having a shorter duration (e.g., one to three OFDM symbols). These mini-slots or shortened transmission time intervals (TTIs) may in some cases be transmitted occupying resources scheduled for ongoing slot transmissions for the same or for different UEs. Any number of resource blocks may be utilized within a subframe or slot.

An expanded view of one of the slots 410 illustrates the slot 410 including a control region 412 and a data region 414. In general, the control region 412 may carry control channels, and the data region 414 may carry data channels. Of course, a slot may contain all DL, all UL, or at least one DL portion and at least one UL portion. The structure illustrated in FIG. 4 is merely an example, and different slot structures may be utilized, and may include one or more of each of the control region(s) and data region(s).

Although not illustrated in FIG. 4, the various REs 406 within an RB 408 may be scheduled to carry one or more physical channels, including control channels, shared channels, data channels, etc. Other REs 406 within the RB 408 may also carry pilots or reference signals. These pilots or reference signals may provide for a receiving device to perform channel estimation of the corresponding channel, which may enable coherent demodulation/detection of the control and/or data channels within the RB 408.

In some examples, the slot 410 may be utilized for broadcast, multicast, groupcast, or unicast communication. For example, a broadcast, multicast, or groupcast communication may refer to a point-to-multipoint transmission by one device (e.g., a base station, UE, or other similar device) to other devices. Here, a broadcast communication is delivered to all devices, whereas a multicast or groupcast communication is delivered to multiple intended recipient devices. A unicast communication may refer to a point-to-point transmission by a one device to a single other device.

In an example of cellular communication over a cellular carrier via a Uu interface, for a DL transmission, the scheduling entity (e.g., a base station) may allocate one or more REs 406 (e.g., within the control region 412) to carry DL control information including one or more DL control channels, such as a physical downlink control channel (PDCCH), to one or more scheduled entities (e.g., UEs). The PDCCH carries downlink control information (DCI) including but not limited to power control commands (e.g., one or more open loop power control parameters and/or one or more closed loop power control parameters), scheduling information, a grant, and/or an assignment of REs for DL and UL transmissions. The PDCCH may further carry hybrid automatic repeat request (HARQ) feedback transmissions such as an acknowledgment (ACK) or negative acknowledgment (NACK). HARQ is a technique well-known to those of ordinary skill in the art, wherein the integrity of packet transmissions may be checked at the receiving side for accuracy, e.g., utilizing any suitable integrity checking mechanism, such as a checksum or a cyclic redundancy check (CRC). If the integrity of the transmission is confirmed, an ACK may be transmitted, whereas if not confirmed, a NACK may be transmitted. In response to a NACK, the transmitting device may send a HARQ retransmission, which may implement chase combining, incremental redundancy, etc.

The base station may further allocate one or more REs 406 (e.g., in the control region 412 or the data region 414) to carry other DL signals, such as a demodulation reference signal (DMRS); a phase-tracking reference signal (PT-RS); a channel state information (CSI) reference signal (CSI-RS); and a synchronization signal block (SSB). SSBs may be broadcast at regular intervals based on a periodicity (e.g., 5, 10, 20, 30, 80, or 130 ms). An SSB includes a primary synchronization signal (PSS), a secondary synchronization signal (SSS), and a physical broadcast control channel (PBCH). A UE may utilize the PSS and SSS to achieve radio frame, subframe, slot, and symbol synchronization in the time domain, identify the center of the channel (system) bandwidth in the frequency domain, and identify the physical cell identity (PCI) of the cell.

The PBCH in the SSB may further include a master information block (MIB) that includes various system information, along with parameters for decoding a system information block (SIB). The SIB may be, for example, a SystemInformationType 1 (SIB1) that may include various additional (remaining) system information. The MIB and SIB1 together provide the minimum system information (SI) for initial access. Examples of system information transmitted in the MIB may include, but are not limited to, a subcarrier spacing (e.g., default downlink numerology), system frame number, a configuration of a PDCCH control resource set (CORESET) (e.g., PDCCH CORESETO), a cell barred indicator, a cell reselection indicator, a raster offset, and a search space for SIB1. Examples of remaining minimum system information (RMSI) transmitted in the SIB1 may include, but are not limited to, a random access search space, a paging search space, downlink configuration information, and uplink configuration information. A base station may transmit other system information (OSI) as well.

In an UL transmission, the UE may utilize one or more REs 406 to carry UL control information (UCI) including one or more UL control channels, such as a physical uplink control channel (PUCCH), to the scheduling entity. UCI may include a variety of packet types and categories, including pilots, reference signals, and information configured to enable or assist in decoding uplink data transmissions. Examples of uplink reference signals may include a sounding reference signal (SRS) and an uplink DMRS. In some examples, the UCI may include a scheduling request (SR), i.e., request for the scheduling entity to schedule uplink transmissions. Here, in response to the SR transmitted on the UCI, the scheduling entity may transmit downlink control information (DCI) that may schedule resources for uplink packet transmissions. UCI may also include HARQ feedback, channel state feedback (CSF), such as a CSI report, or any other suitable UCI.

In addition to control information, one or more REs 406 (e.g., within the data region 414) may be allocated for data traffic. Such data traffic may be carried on one or more traffic channels, such as, for a DL transmission, a physical downlink shared channel (PDSCH); or for an UL transmission, a physical uplink shared channel (PUSCH). In some examples, one or more REs 406 within the data region 414 may be configured to carry other signals, such as one or more SIBs and DMRSs.

In an example of sidelink communication over a sidelink carrier via a proximity service (ProSe) PC5 interface, the control region 412 of the slot 410 may include a physical sidelink control channel (PSCCH) including sidelink control information (SCI) transmitted by an initiating (transmitting) sidelink device (e.g., a transmitting (Tx) V2X device or other Tx UE) towards a set of one or more other receiving sidelink devices (e.g., a receiving (Rx) V2X device or some other Rx UE). The data region 414 of the slot 410 may include a physical sidelink shared channel (PSSCH) including sidelink data traffic transmitted by the initiating (transmitting) sidelink device within resources reserved over the sidelink carrier by the transmitting sidelink device via the SCI. Other information may further be transmitted over various REs 406 within slot 410. For example, HARQ feedback information may be transmitted in a physical sidelink feedback channel (PSFCH) within the slot 410 from the receiving sidelink device to the transmitting sidelink device. In addition, one or more reference signals, such as a sidelink SSB, a sidelink CSI-RS, a sidelink SRS, and/or a sidelink positioning reference signal (PRS) may be transmitted within the slot 410.

These physical channels described above are generally multiplexed and mapped to transport channels for handling at the medium access control (MAC) layer. Transport channels carry blocks of information called transport blocks (TB). The transport block size (TBS), which may correspond to a number of bits of information, may be a controlled parameter, based on the modulation and coding scheme (MCS) and the number of RBs in a given transmission.

The channels or carriers described above with reference to FIGS. 1-4 are not necessarily all of the channels or carriers that may be utilized between a scheduling entity and scheduled entities, and those of ordinary skill in the art will recognize that other channels or carriers may be utilized in addition to those illustrated, such as other traffic, control, and feedback channels.

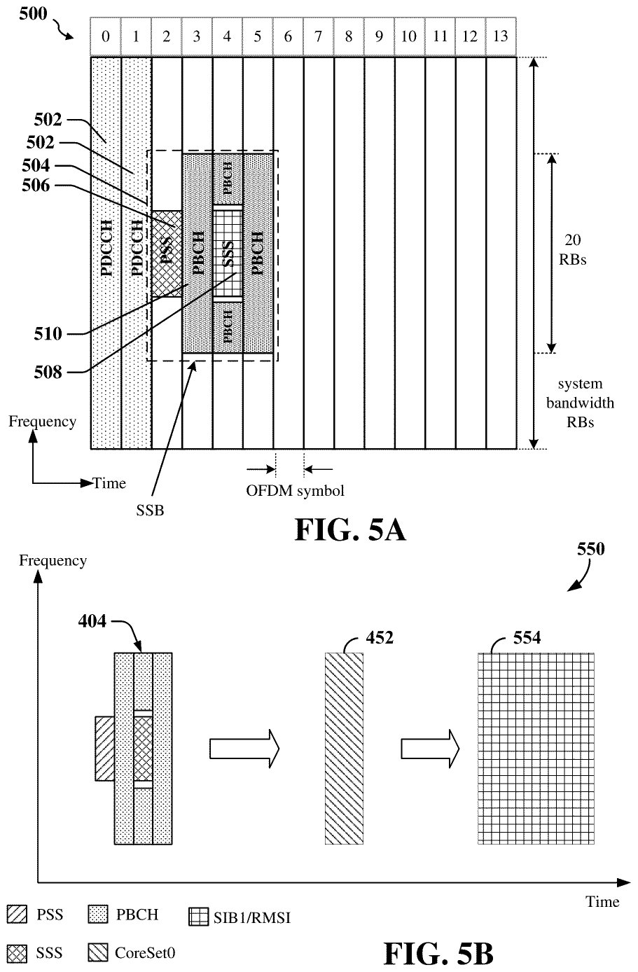

FIG. 5A illustrates an example 500 of various downlink channels within a subframe of a frame including channels used for initial access and synchronization. As shown in FIG. 5A, a physical downlink control channel (PDCCH) 502 is transmitted in at least two symbols (e.g., symbol 0 and symbol 1) and may carry DCI within at least one control channel element (CCE), with each CCE including nine RE groups (REGs), and each RE group (REG) including four consecutive REs in an OFDM symbol. Additionally, FIG. 5A illustrates an exemplary synchronization signal block (SSB) 504 that may be periodically transmitted by a base station or gNB. The SSB 504 carries synchronization signals PSS 506 and SSS 508 and broadcast channels (PBCH) 510. In this example, the SSB 504 contains one PSS symbol (shown in symbol 2), one SSS symbol (shown in symbol 4) and two PBCH symbols (shown in symbols 3 and 5). The PSS and SSS combination may be used to identify physical cell identities. A UE uses the PSS to determine subframe/symbol timing and a physical layer identity. The SSS is used by a UE to determine a physical layer cell identity group number and radio frame timing. Based on the physical layer identity and the physical layer cell identity group number, the UE can determine a physical cell identifier (PCI). Also, based on the PCI, the UE can determine the locations of the aforementioned DMRS. The physical broadcast channel (PBCH), which carries a master information block (MIB), is logically grouped with the PSS and SSS to form the synchronization signal; i.e., the SSB 504. The MIB provides a number of RBs in the system bandwidth and a system frame number (SFN).

FIG. 5B is a diagram illustrating various broadcast information 550 related to initial cell access according to some examples. The broadcast information 550 may be transmitted by a RAN node (e.g., a base station, such as an eNB or gNB) on resources (e.g., time-frequency resources) allocated for the transmission of the broadcast information 550 in a cell. The broadcast information 550 includes the SSB 504 illustrated in FIG. 5A. It is noted that the PBCH in the SSB 504 includes the MIB carrying various system information (SI) including, for example, a cell barred indication, the subcarrier spacing, the system frame number, and scheduling information for a CORESETO 552. For example, the PBCH in the SSB 504 may include scheduling information indicating time-frequency resources allocated for the CORESETO 552. In some examples, the CORESETO 552 may be transmitted within the first four symbols (e.g., within a control region) of a slot. In addition, the CORESETO 552 carries a PDCCH with DCI that contains scheduling information for scheduling the SIB1 554. The SIB1 554 is carried within a physical downlink shared channel (PDSCH) within a data region of a slot. In addition, the SIB1 554 may be referred to as RMSI and includes, for example, a set of radio resource parameters providing network identification and configuration. For example, the set of radio resource parameters may include a bandwidth (e.g., number of BWPs) on which a UE may communicate with a base station.

The MIB in the PBCH may include system information (SI), along with parameters for decoding a SIB (e.g., SIB1). Examples of SI transmitted in the MIB may include, but are not limited to, a subcarrier spacing, a system frame number, a configuration of a PDCCH control resource set (CORESET) (e.g., PDCCH CORESETO), and a search space for SIB1. Examples of SI transmitted in the SIB1 may include, but are not limited to, a random access search space, downlink configuration information, and uplink configuration information. The MIB and SIB1 together provide the minimum SI for initial access.

A brief discussion of an initial access procedure for a UE using the above information follows. As discussed above, a base station (BS) may transmit synchronization signals (e.g., including PSS and SSS) in the network to enable UEs to synchronize with the BS, as well as SI (e.g., including a MIB, RMSI, and OSI) to facilitate initial network access. The BS may transmit the PSS, the SSS, and/or the MIB via SSBs over the PBCH and may broadcast the RMSI and/or the OSI over the PDSCH.

A UE attempting to access a RAN (e.g., the RAN 200 of FIG. 2) may perform an initial cell search by detecting a PSS from a BS (e.g., the PSS of a cell of the BS) of the RAN. The PSS may enable the UE to synchronize to period timing of the BS and may indicate a physical layer identity value assigned to the cell. The UE may also receive an SSS from the BS that enables the UE to synchronize on the radio frame level with the cell. The SSS may also provide a cell identity value, which the UE may combine with the physical layer identity value to identify the cell.

After receiving the PSS and SSS, the UE may receive the SI from the BS. The system information may take the form of the MIB and SIBs discussed above. The system information may include information that a UE can use to access the network such as downlink (DL) channel configuration information, uplink (UL) channel configuration information, access class information, and cell barring information, as well as other information. The MIB may include SI for initial network access and scheduling information for RMSI and/or OSI. After decoding the MIB, the UE may receive the RMSI and/or the OSI.

The SI includes information that enables a UE to determine how to conduct an initial access to a RAN. In some examples, the SIB2 includes random access configuration information (e.g., a random access channel (RACH) configuration) that indicates the resources that the UE is to use to communicate with the RAN during initial access. The random access configuration information may indicate, for example, the resources allocated by the RAN for a RACH procedure. For example, the RACH configuration may indicate the resources allocated by the network for the UE to transmit a physical random access channel (PRACH) preamble and to receive a random access response. In some examples, the RACH configuration identifies RACH occasions (ROs) that specify a set of symbols (e.g., in a PRACH slot) that are scheduled by a base station for the PRACH procedure. The RACH configuration may also indicate the size of a random access response window during which the UE is to monitor for a response to a PRACH preamble. The RACH configuration may further specify that the random access response window starts a certain number of sub-frames after the end of the PRACH preamble in some examples. After obtaining the MIB, the RMSI and/or the OSI, the UE may thus perform a random access procedure for initial access to the RAN.

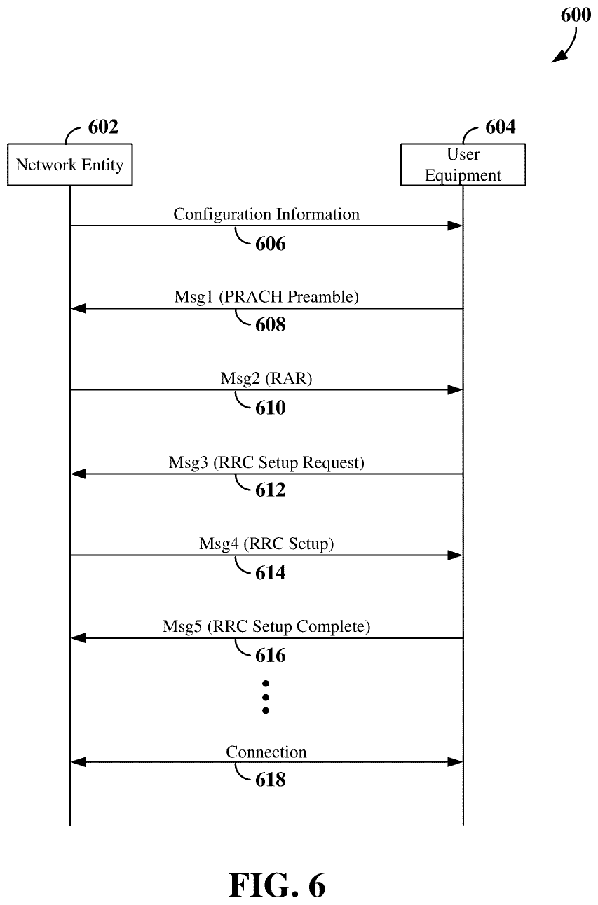

FIG. 6 is a signaling diagram 600 illustrating an example of signaling associated with a contention-based RACH procedure in a wireless communication system including a network entity (e.g., a base station) 602 and a user equipment 604. In some examples, the network entity 602 may correspond to any of the network entities, base stations, CUs, DUs, RUs, or scheduling entities shown in any of FIGS. 1-21. In some examples, the user equipment 604 may correspond to any of the UEs or scheduled entities shown in any of FIGS. 1-21.

At #606 of FIG. 6, the network entity 602 broadcasts configuration information that nearby devices (e.g., the user equipment 604) may use for a RACH procedure directed to the network entity 602. For example, the network entity 602 may broadcast the random access-related SI discussed above.

At #608 of FIG. 6, the user equipment 604 transmits a message 1 (which may be referred to as Msg1) of the RACH procedure to the network entity 602. In some examples, the Msg1 is a PRACH preamble. RACH Msg1 may be referred to as PRACH. As mentioned above, the user equipment 604 may transmit the PRACH preamble on resources specified by a RACH configuration included in SIB2.

At #610, the network entity 602 responds to the PRACH preamble with a message 2 (which may be referred to as Msg2) of the RACH procedure. The Msg2 may be referred to informally as a random access response (RAR). In some examples of 610, the network entity 602 transmits a DCI on a PDCCH, where the DCI schedules a PDSCH (e.g., the DCI specifies the resources for the PDSCH transmission). The network entity 602 then transmits the PDSCH which includes the RAR data such as, for example, an UL grant for the user equipment to transmit a message 3 (which may be referred to as Msg3) of the RACH procedure.

In some examples, the user equipment monitors for the RACH Msg2 on resources specified by the RACH configuration during the RAR window specified by the RACH configuration. For example, the user equipment may decode the DCI carried on the PDCCH and then decode the RAR carried on the PDSCH.

At #612, upon receiving all of the RAR information, the user equipment 604 transmits the Msg3 of the RACH procedure. In some examples, the RACH Msg3 is a radio resource control (RRC) Setup Request message.

At #614, the network entity 602 responds with a message 4 (which may be referred to as Msg4) of the RACH procedure. In some examples, the RACH Msg4 is an RRC Setup message (e.g., a contention resolution message).

At #616, the user equipment 604 responds with a message 5 (which may be referred to as Msg5) of the RACH procedure. In some examples, the RACH Msg5 is an RRC Setup Complete message. In some examples, if the user equipment 604 successfully decodes the RACH Msg 4, the transmission of RACH Msg5 may involve transmitting a PUCCH including a HARQ-ACK for the PDSCH data of RACH Msg4. In some examples, PUCCH frequency hopping may be used for this transmission of the RACH Msg5.

As indicated by 618, the network entity 602 and the user equipment 604 ultimately establish a connection and enter an active operational phase where data may be exchanged. For example, the network entity 602 may schedule the user equipment 604 for UL communication and/or DL communication.

5G-NR networks may further support carrier aggregation (CA) of component carriers transmitted from different cells and/or different transmission and reception points (TRPs) in a multi-cell transmission environment. The different TRPs may be associated with a single serving cell or multiple serving cells. In some aspects, the term component carrier may refer to a carrier frequency (or band) utilized for communication within a cell.

In some aspects, a TRP may refer to a physical entity that incorporates RU functionality for a particular physical cell. This functionality may be similar in one or more aspects to (or incorporated into) the RU functionality of a NodeB, an eNodeB, a gNodeB, a radio network controller (RNC), a base station (BS), a radio base station (RBS), a base station controller (BSC), a base transceiver station (BTS), a transceiver function (TF), a radio transceiver, a radio router, a basic service set (BSS), an extended service set (ESS), a macro cell, a macro node, a Home eNB (HeNB), or some other similar entity.

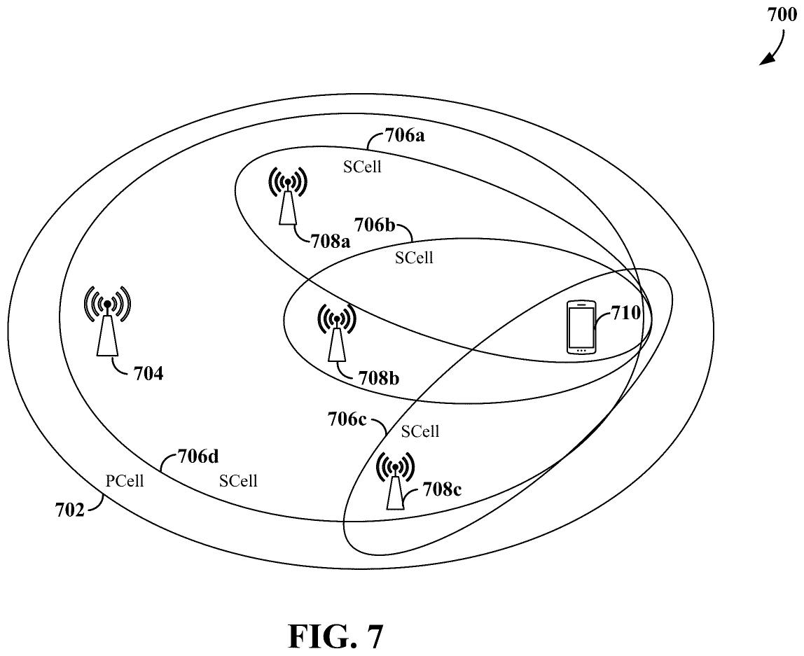

FIG. 7 is a conceptual illustration of a wireless communication system that shows a base station (BS) and a user equipment (UE) communicating via multiple carriers according to some aspects of the disclosure. In particular, FIG. 7 shows an example of a wireless communication system 700 that includes a primary serving cell (PCell) 702 and one or more secondary serving cells (SCells) 706a, 706b, 706c, and 706d. The PCell 702 may be referred to as the anchor cell that provides a radio resource control (RRC) connection to the UE 710. In some examples, the PCell and the SCell may be co-located (e.g., different TRPs at the same location). The UE 710 may correspond to any of the UEs or scheduled entities shown in any of FIGS. 1, 2, 3, and 14.

One or more of the SCells 706a-706d may be activated or added to the PCell 702 to form the serving cells serving the UE 710. Each serving cell corresponds to a component carrier (CC). The CC of the PCell 702 may be referred to as a primary CC, and the CC of a SCell 706a-706d may be referred to as a secondary CC. The PCell 702 and one or more of the SCells 706 may be served by a respective base station 704 and 708a-708c or scheduling entity similar to those illustrated in any of FIGS. 1, 2, 4, and 16. In the example shown in FIG. 7, SCells 706 a-706c are each served by a respective base station 708a-708c. SCell 706d is co-located with the PCell 702. For example, the base station 704 may include multiple TRPs, each supporting a different carrier. The coverages of the PCell 702 and SCell 706d may differ since component carriers in different frequency bands may experience different path loss.

In some examples, the PCell 702 may add or remove one or more of the SCells 706a-706d to improve reliability of the connection to the UE 710 and/or increase the data rate. The PCell 702 may be changed upon a handover to another PCell.

In some examples, the PCell 702 may utilize a first radio access technology (RAT), such as LTE, while one or more of the SCells 706 may utilize a second RAT, such as 5G-NR. In this example, the multi-cell transmission environment may be referred to as a multi-RAT-dual connectivity (MR-DC) environment. One example of MR-DC is Evolved-Universal Terrestrial Radio Access Network (E-UTRAN)-New Radio (NR) dual connectivity (EN-DC) mode that enables a UE to simultaneously connect to an LTE base station and a NR base station to receive data packets from and send data packets to both the LTE base station and the NR base station.

In some examples, the PCell 702 may be a low band cell, and the SCells 706 may be high band cells. A low band (LB) cell uses a CC in a frequency band lower than that of the high band cells. For example, the high band cells may use millimeter wave (mmW) CC, and the low band cell may use a CC in a band (e.g., sub-6 GHz band) lower than mmW. In general, a cell using a mmW CC can provide greater bandwidth than a cell using a low band CC. In addition, when using a frequency carrier that is above 6 GHz (e.g., mmW), beamforming may be used to transmit and receive signals in some examples.

Various types of cells may be deployed in a wireless communication system in different examples. In some examples, a cell may be a special cell (SpCell) such as a primary cell (PCell), a primary secondary cell (PSCell), or a PUCCH secondary cell (PUCCH SCell). In some examples, an SpCell may be a PCell for a master cell group (MCG) or a PSCell for a secondary cell group (SCG).

For uplink transmissions, a 5G NR uplink allows for uplink intracell orthogonality so that the uplink transmissions received from different devices within a cell do not interfere with each other. To enable such uplink orthogonality, the uplink slot boundaries for a given numerology are (approximately) time aligned at the network entity. To ensure such receiver-side time alignment, a network entity may transmit a timing advance (TA) signal or indication to a UE so that the UE may adjust its uplink timing accordingly.

Generally, timing advance is a negative offset applied at a wireless device (e.g., a UE) between the start of a downlink (DL) symbol (or subframe) as observed by the device and the start of a symbol in the uplink (UL). By controlling the offset appropriately for each device, the network (e.g., a network entity such as a gNB) may control the timing of the signals received at the network entity from the various devices (UEs) in a cell being served. Devices located far from the network entity encounter a longer propagation delay, and, therefore, should start their uplink transmissions somewhat in advance, compared to devices located closer to the network entity that encounter a shorter propagation delay.

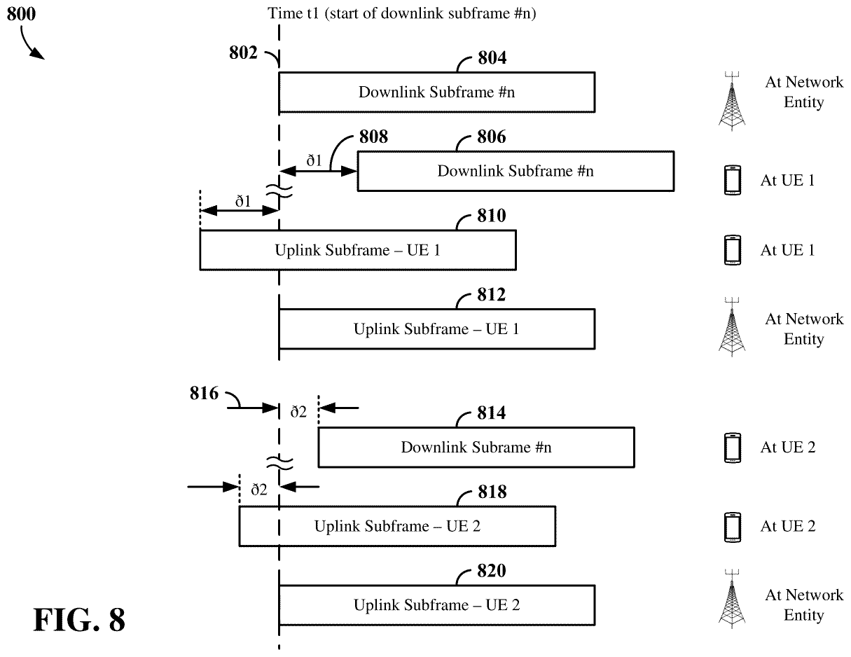

FIG. 8 illustrates an example 800 of downlink and uplink timing. In this example, a first UE (UE 1) is located further from a network entity (e.g., a gNB) than a second UE (UE 2). Time-aligned downlink transmissions and uplink transmissions are illustrated relative to a time t1 802 that represents a subframe boundary at the network entity.

As represented by a downlink subframe 804 (designated as downlink subframe #n in this example), transmission of a downlink subframe at the network entity starts at the time t1 802. A downlink subframe 806 represents the delayed reception of the downlink subframe 804 at the first UE (UE 1). As indicated, the subframe 806 is received at the first UE (UE 1) after a propagation delay δ1 808.

In some aspects, it may be desired that uplink transmissions be received at the network entity time aligned with the network entity's subframe boundary. To this end, based on a timing advance command received from the network entity, the first UE (UE 1) may transmit an uplink subframe 810 at a time that precedes the network entity's subframe boundary by the propagation delay δ1. An uplink subframe 812 represents the delayed reception of the uplink subframe 810 at the network entity. As indicated, this uplink subframe is received time aligned with the network entity's subframe boundary. For convenience, the transmission of the uplink subframe is depicted relative to the time t1 802. It should be appreciated, however, that in a half-duplex system the relative subframe boundary for the uplink transmission would be later in time than the time t1 802.

FIG. 8 further illustrates that the propagation delay δ2 from the network entity to the second UE (UE 2) is shorter than the propagation delay δ1 due to the second UE (UE 2) being closer to the network entity than the first UE (UE 1). A downlink subframe 814 represents the delayed reception of the downlink subframe 804 at the second UE (UE 2). As indicated, the subframe 814 is received at the second UE (UE 2) after a propagation delay δ2 816.

Based on a timing advance command received from the network entity, the second UE (UE 2) may transmit an uplink subframe 818 at a time that precedes the network entity's subframe boundary by the propagation delay δ2. An uplink subframe 820 represents the delayed reception of the uplink subframe 818 at the network entity. As indicated, this uplink subframe is received time aligned with the network entity's subframe boundary. For convenience, the transmission of the uplink subframe is again depicted relative to the time t1 802. It should be appreciated, however, that in a half-duplex system the relative subframe boundary for the uplink transmission would be later in time than the time t1 802.

Some wireless communication systems (e.g., 3GPP LTE and NR) use upper layer mobility (e.g., based on Layer 3, RRC signaling) to enable a UE to move from one cell to another. Here, the UE connects to a single cell at a time. For example, a UE may initially be connected to a serving cell. Subsequently, upon receiving a cell switch command, the UE may connect to a new cell.

As discussed above, a handover operation in such a system (e.g., based on Layer 3, RRC signaling) may involve a RACH procedure.

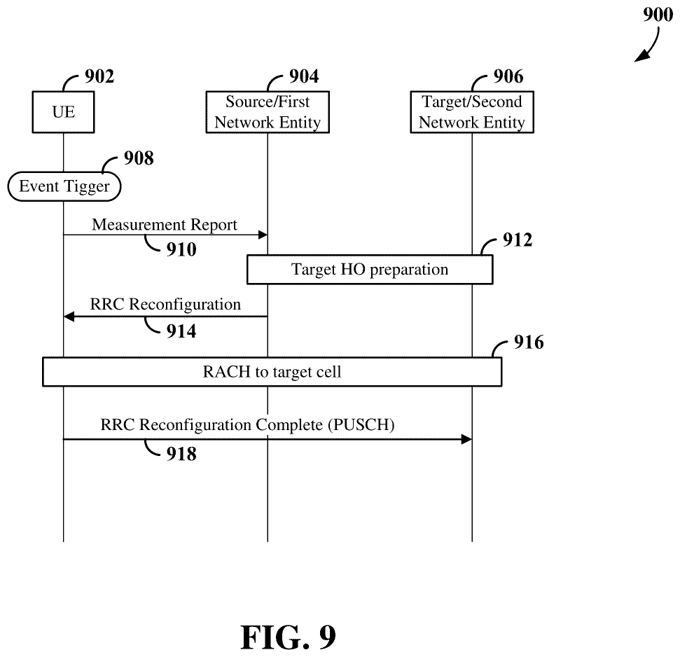

FIG. 9 is a signaling diagram 900 illustrating an example of signaling associated with a RACH-based handover in a wireless communication system including a user equipment 902, a first network entity 904 (e.g., a source gNB), and a second network entity 906 (e.g., a target gNB). In some examples, the user equipment 902 may correspond to any of the UEs or scheduled entities shown in any of FIGS. 1-22. In some examples, the first network entity 904 and the second network entity 906 may correspond to any of the network entities, base stations, CUs, DUs, RUs, or scheduling entities shown in any of FIGS. 1-22.

At #908 of FIG. 9, an event trigger may cause the user equipment 902 to generate a measurement report and transmit the measurement report at #910. For example, based on measurements of signals from the first network entity 904 and one or more other network entities, the user equipment 902 may determine that a measured signal falls below or above a particular threshold. Examples of event triggers used in 3GPP-based systems include Event A1 (serving cell>threshold), Event A2 (serving cell<threshold), Event A3 (neighbor cell>threshold+offset), Event A4 (neighbor cell>threshold), Event A5 (SpCell<threshold1 and neighbor cell>threshold2), and Event A6 (neighbor cell>SpCell+offset). Other event triggers may be used in other examples.

At #912, based on the measurement report, the first network entity 904 may elect to handover the user equipment to the second network entity 906. Thus, the first network entity 904 and the second network entity 906 may cooperate to prepare the second network entity 906 as the target for handover of the user equipment 902.

At #914, the first network entity 904 sends an RRC reconfiguration message to the user equipment 902 to inform the user equipment 902 that is it being handed-over to the second network entity 906. In some aspects, this RRC reconfiguration message may be referred to as (or referred to as including) a cell switch command.

At #916, upon receiving the RRC configuration message, the user equipment 902 conducts a RACH procedure (e.g., as discussed above in conjunction with FIG. 6) with the second network entity 906. Here, upon receiving a PRACH from the user equipment 902, the second network entity 906 may determine a timing advance value, a power control value, and beam information that can be used (e.g., by the user equipment) to establish communication between the user equipment 902 and the second network entity 906.

At #918, in conjunction with completing the RACH procedure, the user equipment 902 sends an RRC reconfiguration complete message to the second network entity 906. The user equipment 902 may thereby be served by the second network entity 906 instead of the first network entity 904.

Some wireless communication systems (e.g., 3GPP LTE and NR) may support a RACH-less handover. For example, in certain defined scenarios (e.g., handover to or from a small cell), when initiating communication with a target cell a UE may use the same TA value that it used for communicating with the source cell.

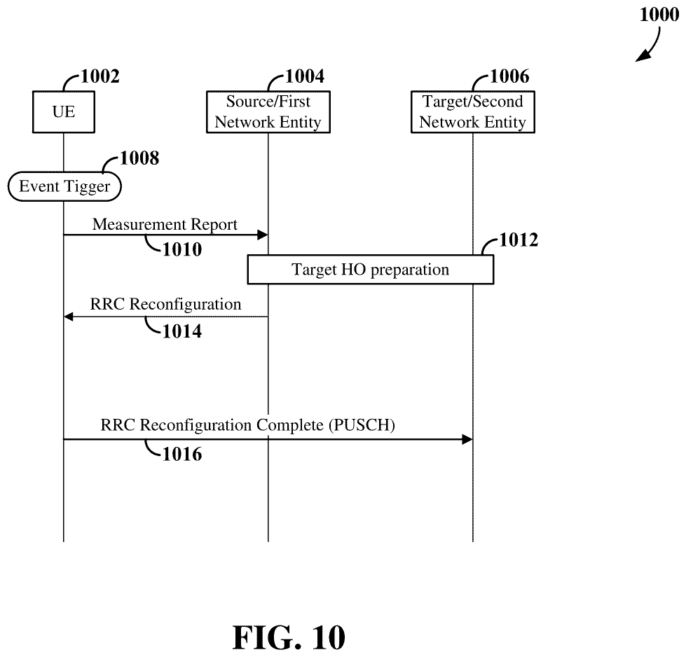

FIG. 10 is a signaling diagram 1000 illustrating an example of signaling associated with a RACH-based handover in a wireless communication system including a user equipment 1002, a first network entity 1004 (e.g., a source gNB), and a second network entity 1006 (e.g., a target gNB). In some examples, the user equipment 1002 may correspond to any of the UEs or scheduled entities shown in any of FIGS. 1-22. In some examples, the first network entity 1004 and the second network entity 1006 may correspond to any of the network entities, base stations, CUs, DUs, RUs, or scheduling entities shown in any of FIGS. 1-22.

At #1008 of FIG. 10, an event trigger may cause the user equipment 1002 to generate a measurement report and transmit the measurement report at #1010. For example, based on measurements of signals from the first network entity 1004 and one or more other network entities, the user equipment 1002 may determine that a measured signal falls below or above a particular threshold. Examples of event triggers used in 3GPP-based systems include Event A1 (serving cell>threshold), Event A2 (serving cell<threshold), Event A3 (neighbor cell>threshold+offset), Event A4 (neighbor cell>threshold), Event A5 (SpCell<threshold1 and neighbor cell>threshold2), and Event A6 (neighbor cell>SpCell+offset). Other event triggers may be used in other examples.

At #1012, based on the measurement report, the first network entity 1004 may elect to handover the user equipment to the second network entity 1006. Thus, the first network entity 1004 and the second network entity 1006 may cooperate to prepare the second network entity 1006 as the target for handover of the user equipment 1002.

At #1014, the first network entity 1004 sends an RRC reconfiguration message to the user equipment 1002 to inform the user equipment 1002 that is it being handed-over to the second network entity 1006. In some aspects, this RRC reconfiguration message may be referred to as (or referred to as including) a cell switch command.

At #1016, upon receiving the RRC configuration message, the user equipment 1002 sends an RRC reconfiguration complete message to the second network entity 1006 without conducting the RACH procedure. The user equipment 1002 may thereby establish the connection with the second network entity 1006 more quickly as compared to a RACH-based handover.

In some wireless communication systems (e.g., 3GPP NR Release 18), mobility (e.g., including handover procedures) may be based on Layer 1 (physical layer) and Layer 2 (MAC layer) signaling for fast cell switching. Conventionally, Layer 1 may be referred to as L1 and Layer 2 may be referred to as L2. In some aspects, such L1/L2 based mobility may be applicable to any of the following scenarios. L1/L2 mobility may involve a standalone mode of operation, a carrier aggregation (CA) mode of operation, or an NR-DC mode of operation, where there is a serving cell change within one CG. L1/L2 mobility may involve an intra-DU case or an intra-CU-inter-DU case (applicable for standalone and CA). L1/L2 mobility may involve intra-frequency or inter-frequency operation. L1/L2 mobility may involve a FR1 or FR2 operation. L1/L2 mobility may involve scenarios whether the source and target cells are synchronized or non-synchronized.

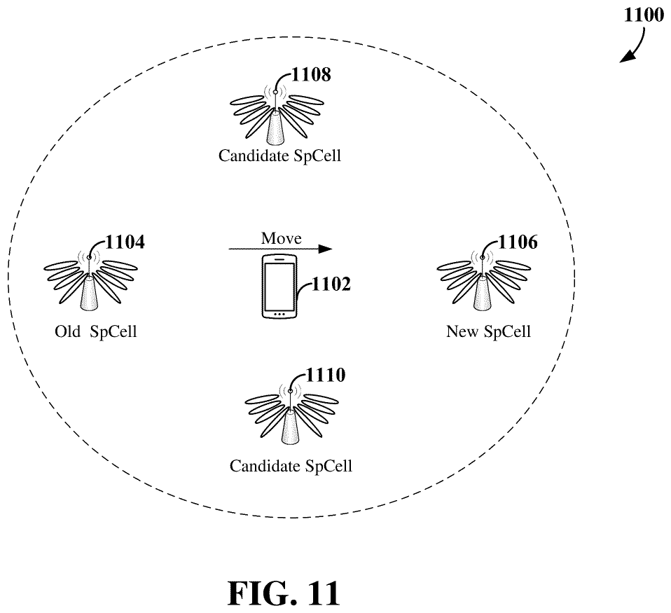

FIG. 11 illustrates an example 1100 of L1/L2 based inter-cell mobility illustrating a single SpCell change (without CA) for a UE 1102 via L1/L2 signaling based on L1 measurements. In the example of FIG. 11, the UE 1102 is initially served by an SpCell 1104. In addition, a set of candidate SpCells (e.g., including SpCell 1106, SpCell 1108, and SpCell 1110) may be preconfigured for the UE 1102. Based on measurements of the candidate SpCells by the UE 1102, the UE may be handed over to the SpCell 1106.

When L1/L2 mobility is used, a UE that is connected to a serving SpCell may also obtain configuration information about candidate SpCells from the serving cell of the UE. Based on this configuration information, the UE may transmit and receive information to and from these candidate SpCells. For example, a UE may conduct measurements of candidate SpCells and select a target SpCell using the L1/L2 signaling. By using L1/L2 signaling, handover latency may be reduced as compared to L3 handover.

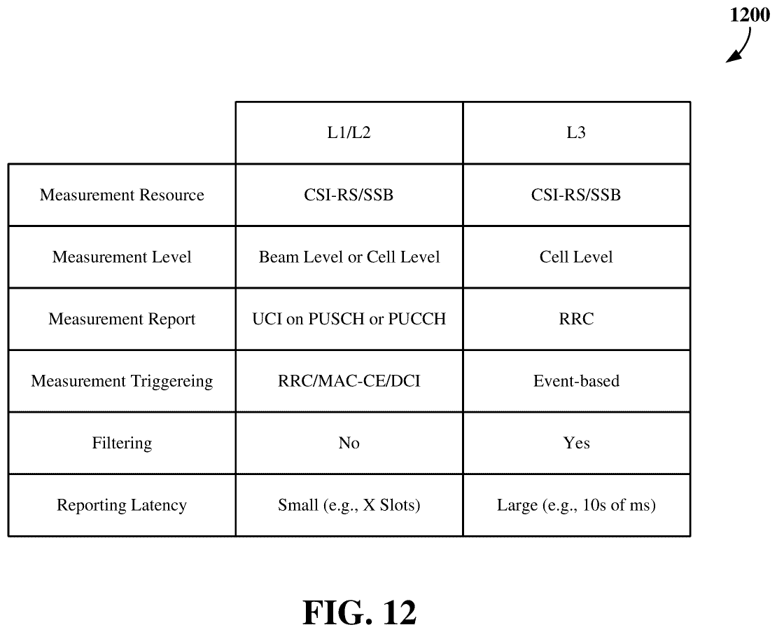

FIG. 12 depicts a table 1200 that describes some of the differences that may exist between L3 mobility and L1/L2 mobility. Of note, for L1/L2 mobility, measurement may be conducted at the beam level. In addition, a measurement report may be sent via uplink control information, which may involve less delay than the RRC signaling used in L3 mobility. Furthermore, L1/L2 measurements may be triggered by RRC signaling, MAC-CE-signaling, or DCI signaling, which further reduce handover latency as compared to L3 mobility which uses event-based triggering. Also, filtering of multiple measurements need not be performed for L1/L2 mobility (e.g., an L1 measurement may be conducted for a single time location), which can further reduce the handover latency as compared to L3 mobility which uses filtering. Also, a UE may have a dedicated CSI report configuration for L1 measurements, where the CSI report configuration is associated with the physical layer.

The disclosure relates in some aspects to techniques using HARQ-less handover in an L1/L2 mobility scenario. By eliminating HARQ signaling, handover latency may be further reduced.

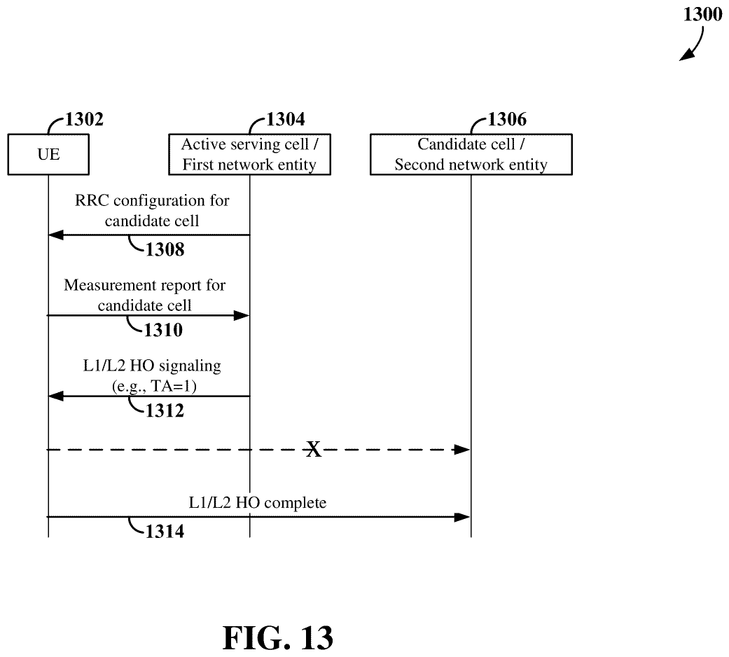

FIG. 13 is a signaling diagram 1300 illustrating an example of signaling associated with a RACH-less L1/L2 handover in a wireless communication system including a user equipment 1302, a first network entity 1304 (e.g., associated with an active serving cell), and a second network entity 1306 (e.g., associated with a candidate cell). In some examples, the user equipment 1302 may correspond to any of the UEs or scheduled entities shown in any of FIGS. 1-22. In some examples, the first network entity 1304 and the second network entity 1306 may correspond to any of the network entities, base stations, CUs, DUs, RUs, or scheduling entities shown in any of FIGS. 1-22.

At #1308 of FIG. 13, the first network entity 1304 sends an RRC configuration message to the user equipment 1302, where the RRC configuration message includes configuration information about one or more candidate cells for potential handover of the user equipment 1302. In some examples, the configuration information may indicate resources and other parameters used by each candidate cell for transmitting information (e.g., CSI-RS, SSBs, etc.) and receiving information (e.g., SRSs, etc.).

At #1310, based on the configuration information, the user equipment 1302 may conduct signal measurements, generate a measurement report (e.g., a beam report), and transmit the measurement report to the first network entity 1304.

At #1312, based on the measurement report, the first network entity 1304 may elect to handover the user equipment to the second network entity 1306. Thus, the first network entity 1304 sends a L1/L2 handover message to the user equipment 1302 to inform the user equipment 1302 that is it being handed-over to the second network entity 1306. In some aspects, this L1/L2 handover message may be referred to as (or referred to as including) a cell switch command. In some examples, the L1/L2 handover message may include an indication of the timing advance value to be used by the user equipment 1302 when communicating with the second network entity 1306. In some examples, the L1/L2 handover message may be implemented using MAC-CE signaling. In some examples, the L1/L2 handover message may be implemented using DCI signaling.

In this case, the user equipment 1302 does not send a PRACH message to the second network entity 1306 (as represented by the X'ed out dashed line in FIG. 13). Instead, at #1314, upon receiving the L1/L2 handover message, the user equipment 1302 sends an L1/L2 handover complete message to the second network entity 1306. The user equipment 1302 may thereby establish the connection with the second network entity 1306 more quickly as compared to a RACH-based handover. In some examples, the L1/L2 handover complete message may be implemented using MAC-CE signaling. In some examples, the L1/L2 handover complete message may be implemented using DCI signaling.

The disclosure relates in some aspects to techniques for triggering a UE to transmit a PRACH message for a candidate cell. For example, for L1/L2 based mobility, a network entity (e.g., a gNB) may send a PDCCH order to a UE to trigger a PRACH transmission for candidate cells for only TA, beam, or power control related measurement purposes. In this case, there may be no need to perform a full PRACH procedure.

The disclosure relates in some aspects to techniques for informing a UE that the UE is to transmit only a PRACH message of the RACH procedure for candidate cells in response to a PDCCH order. In some examples, a network entity may send such an indication to a UE.

In a first example, a network entity uses explicit signaling to inform a UE that it is to transmit only a PRACH message in response to a PDCCH order. In some examples, this explicit signaling involves including at least one indication in at least one field (e.g., at least one dedicated field and/or at least one existing field that is repurposed) of the PDCCH order. In some examples, the explicit signaling involves a single bit in the PDCCH order to indicate whether it is only for a PRACH message. In some examples, this explicit signaling involves including at least one indication in at least one field of a message other than the PDCCH order.

For a scenario where the PDCCH order includes at least one field for indicating that the UE is to transmit only a PRACH message cells in response to a PDCCH order, different field configurations may be used in different examples. In some examples, a single field is used for such an indication. For example, a frequency domain resource allocation field of the PDCCH order may be set to all zeros (0s) or all ones (1s) to indicate whether the UE is to transmit only a PRACH message or whether the UE is to expect a Msg2 of the RACH procedure in response to the PRACH message. As another example, an uplink/supplemental uplink (UL/SUL) indicator field of the PDCCH order may be used to indicate whether the UE is to transmit only a PRACH message or whether the UE is to expect a Msg2 in response to the PRACH message.

In some examples, multiple fields of a PDCCH order may be used for such an indication. For example, a first field (e.g., an UL/SUL indicator field) may indicate whether the PDCCH order is a modified PDCCH order for only a PRACH message or a legacy PDCCH order for a full RACH procedure. In addition, a second field (e.g., a frequency domain resource allocation (FDRA) field) of the PDCCH order may indicate whether the UE is to transmit only a PRACH message or whether the UE is to expect a Msg2 in response to the PRACH message.

For a scenario where the indication is provided in signaling other than the PDCCH order, a network entity may send the indication to the UE prior to sending the PDCCH order to indicate the triggered PRACH is for only a PRACH message. For example, the network entity may send an RRC message, a MAC-CE, DCI, or other signaling that includes the indication to the UE prior to sending the PDCCH order.

In some examples, a UE may be provided with such an indication via implicit signaling or a rule. For example, a predefined rule (e.g., specified by a wireless communication standard, such as a 3GPP technical specification) may specify that for all candidate cells, the PDCCH order triggers only a PRACH. In this case, when a UE receives a PDCCH order instructing the UE to transmit a PRACH to a candidate cell, the UE may transmit only the PRACH (and not generate or expect any other RACH signaling in conjunction with that PDCCH order). In this case, a 2-step or 4-step RACH procedure may still be used when the UE receives a PDCCH order that requests the UE to transmit a RACH message to an active serving cell.

As another example, a predefined rule may specify that for all non-active candidate cells (e.g., deactivated PCells or SCells), the PDCCH order only triggers a PRACH. In this case, when a UE receives a PDCCH order instructing the UE to transmit a PRACH to a non-active candidate cell, the UE may transmit only the PRACH (and not generate or expect any other RACH signaling in conjunction with that PDCCH order). In this case, a 2-step or 4-step RACH procedure may still be used when the UE receives a PDCCH order that requests the UE to transmit a RACH message to an active serving cell or an active candidate cell.

The disclosure relates in some aspects to sending PRACH power control (PC) parameters to a UE. In some aspects, a network entity may dynamically signal a PRACH power adjustment parameter to the UE (e.g., a PRACH power adjustment parameter may be any of a target PRACH receive power, a target PRACH receive power delta value, and a PRACH transmit power delta value). In some examples, the UE may be configured with multiple target PRACH receive powers, and the network entity may dynamically signal one of target PRACH receive powers to the UE in the PDCCH order. In some examples, the UE may be configured with multiple PRACH transmit power delta values, and the network entity may dynamically signal one of PRACH transmit power delta values in the PDCCH order to indicate (e.g., instruct) the UE to increase (or decrease) the transmit power for the PRACH message from the last transmission of a PRACH message.

In some examples, the PC parameters may be included in the PDCCH order. For example, the transmit power control (TPC) field of the PDCCH order may include a PRACH power adjustment parameter.

In some examples, the PC parameters may be included in signaling other than the PDCCH order. For example, the network entity may send DCI to the UE where the DCI has a TPC field that includes a PRACH power adjustment parameter. As another example, a candidate cell may send a PDCCH message (e.g., DCI) to the UE where the PDCCH message has a TPC field that includes a PRACH power adjustment parameter. As a further example, the network entity may send a MAC-CE that includes a PRACH power adjustment parameter to the UE.

The disclosure relates in some aspects to sending a PRACH repetition indication to a UE. In some scenarios, a network entity (e.g., a gNB) may indicate that a UE is to transmit a burst of X PRACH-only transmissions (e.g., for periodic TA measurements). In addition, the network entity may indicate a corresponding PRACH transmission interval for the burst of X PRACH-only transmissions. In some examples, the network entity may activate and deactivate semi-persistent PRACH-only transmissions and the corresponding interval(s) for the semi-persistent PRACH-only transmissions. In some examples, the network entity may indicate a quantity of beams that the UE is to use for beam sweeping transmissions of a burst of X PRACH-only transmissions. The network entity may send the above indications to the UE via a PDCCH order, an RRC message, a MAC-CE, DCI, or other signaling.

The disclosure relates in some aspects to a non-RACH occasion-based PRACH. For example, the time location of a trigged PRACH location may be defined relative to the PDCCH order DCI. As one example, a UE may be configured to transmit a triggered PRACH in the next feasible slot(s) that is/are able to accommodate the PRACH message after a time offset from the PDCCH order DCI.

The time offset between the PDCCH order and the trigged PRACH message may be different for intra-frequency candidate cells versus inter-frequency candidate cells. For example, the time offset for intra-frequency candidate cells may be shorter than the time offset for inter-frequency candidate cells.

The time offset may be different for active candidate cells versus inactive candidate cells. For example, the time offset for active candidate cells may be shorter than the time offset for inactive candidate cells.

In some examples, a time offset may be preconfigured in the UE. In some examples, a network entity may send an indication of the time offset to the UE via a PDCCH order, an RRC message, a MAC-CE, DCI, or other signaling.

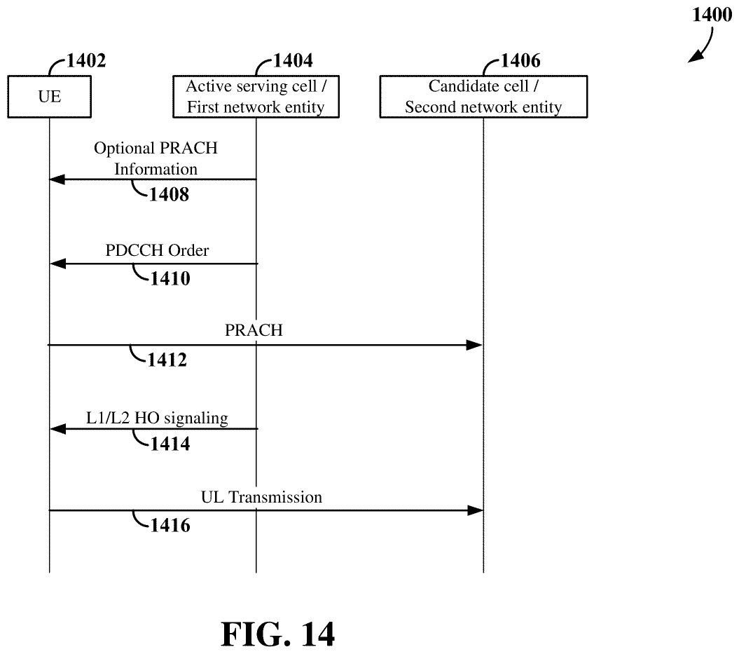

FIG. 14 is a signaling diagram 1400 illustrating an example of a triggered PRACH in a wireless communication system including a user equipment 1402, a first network entity 1404 (e.g., the active serving cell), and a second network entity 1406 (e.g., a candidate cell). In some examples, the user equipment 1402 may correspond to any of the UEs or scheduled entities shown in any of FIGS. 1-22. In some examples, the first network entity 1404 and the second network entity 1406 may correspond to any of the network entities, base stations, CUs, DUs, RUs, or scheduling entities shown in any of FIGS. 1-22.

At optional #1408 of FIG. 14, the first network entity 1404 (e.g., associated with the active serving cell for the user equipment 1402) may send PRACH information (e.g., a PRACH configuration) to the user equipment 1402. In some examples, the PRACH information may be included in an RRC message, a MCA-CE, a DCI, or some other type of signaling.

In some examples, the PRACH information may indicate that the user equipment 1402 is to send only a PRACH message (e.g., not send or monitor for any other RACH messages) in response a PDCCH order. For example, it may be desirable for the user equipment 1602 to send only a PRACH message to a candidate cell to enable the candidate cell to determine timing advance, beam, and power control information that may be used on conjunction with handover of the user equipment to the candidate cell. In some aspects, a PRACH message is sufficient for this purpose. Thus, by omitting other steps (e.g., Msg2, Msg3, etc., of the RACH procedure), the latency and overhead of this procedure may be lower as compared to a conventional RACH procedure.

In some examples, the PRACH information may indicate that the user equipment 1402 is to send only a PRACH for a particular PDCCH order (e.g., the next PDCCH order, a PDCCH order associated with a particular candidate cell, etc.). In some examples, the PRACH information may indicate that the user equipment 1402 is to send only a PRACH for a particular type of PDCCH order (e.g., a PDCCH order associated with candidate cells, a PDCCH order associated with deactivated candidate cells, etc.).

In some examples, the PRACH information may specify one or more parameters for the user equipment 1402 to use when transmitting a PRACH. For example, the PRACH information may include PRACH power configuration (e.g., adjustment) information. As another example, the PRACH information may include PRACH repetition information. As a further example, the PRACH information may include PRACH offset information.

At #1410, at some point in time (e.g., in preparation for handover of the user equipment 1402 to a candidate cell), the first network entity 1404 sends a PDCCH order to the user equipment 1402. In some examples, the PDCCH order instructs the user equipment to transmit a PRACH to at least one candidate cell (e.g., including a cell served by the second network entity 1406).

In some examples, the PDCCH order includes some or all of the PRACH information discussed at #1408. For example, the PDCCH order may include at least one field that carries an indication of whether the user equipment 1402 is to send only a PRACH in response a PDCCH order. As another example, the PDCCH order may include at least one field that carries at least one of PRACH power configuration information, PRACH repetition information, or PRACH offset information.

At #1412, in response to the PDCCH order received at #1410, the user equipment 1402 transmits a PRACH to the second network entity 1406 (and, potentially, to other network entities). Here, the user equipment 1402 may be configured to transmit to and receive from a set of candidate cells while the user equipment 1402 is still connected to its active service cell.

The user equipment 1402 may determine whether it is to transmit only the PRACH (and no other RACH messages) in response to the PDCCH order. For example, the user equipment 1402 may have received an indication (e.g., as discussed above) specifying that the user equipment 1402 is to transmit only the PRACH to a candidate cell served by the second network entity 1406 in response to the PDCCH order. As another example, there may be a defined rule (e.g., specified by a wireless communication standard, such as a 3GPP technical specification) that specifies that the user equipment 1402 is to transmit only the PRACH to a candidate cell (or certain candidate cells) in response to a PDCCH order.

In some examples, the user equipment 1402 may transmit the PRACH based on PRACH information the user equipment 1402 received from the first network entity. For example, the user equipment 1402 may transmit the PRACH at a transmit power that is based on the PRACH power configuration information. As another example, the user equipment 1402 may repeatedly transmit the PRACH based on the PRACH repetition information. As a further example, the user equipment 1402 may transmit the PRACH at a time that is based on the PRACH offset information.

At some point in time (e.g., based on a measurement report received from the user equipment 1402 and/or based on cell conditions determined as a result of the transmission of the PRACH at #1412), the first network entity 1404 may elect to handover the user equipment to the second network entity 1406. Thus, at #1414, the first network entity 1404 sends a L1/L2 handover message to the user equipment 1402 to inform the user equipment 1402 that is it being handed-over to the second network entity 1406. In some aspects, this L1/L2 handover message may be referred to as including a cell switch command. In some examples, the L1/L2 handover message may be implemented using MAC-CE signaling. In some examples, the L1/L2 handover message may be implemented using DCI signaling.

At #1416, upon receiving the L1/L2 handover message, the user equipment 1402 sends an uplink transmission to the second network entity 1406. For example, the user equipment may transmit an L1/L2 handover complete message to the second network entity 1406 as discussed above.

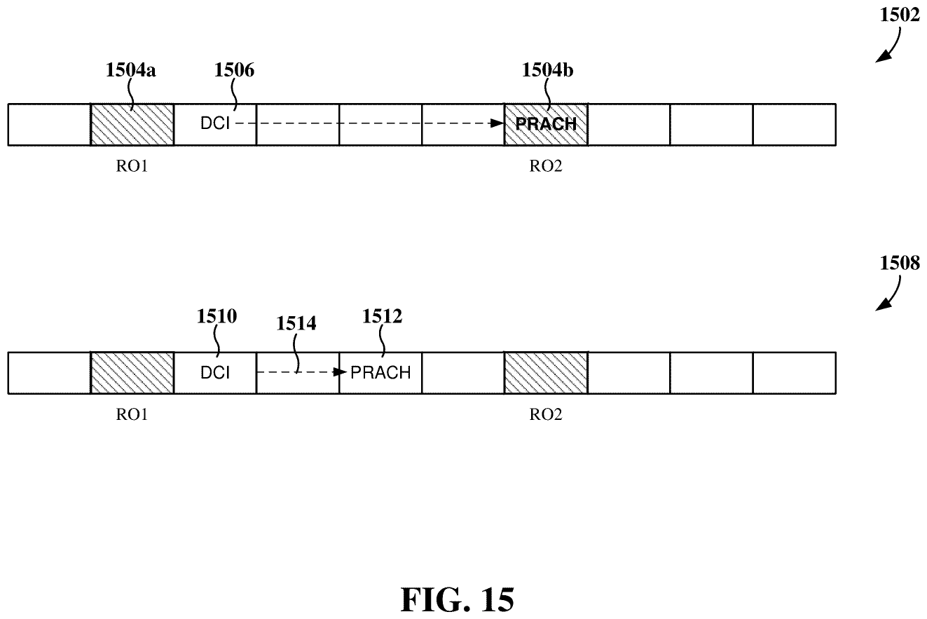

FIG. 15 illustrates an example of how a PRACH offset may be used to reduce PRACH-related latency as compared to a conventional RACH procedure.

The diagram 1502 illustrates a conventional triggered RACH procedure where a RACH configuration specifies that the triggered RACH messages may be sent only during specified RACH occasions (e.g., RO 1504a and RO 1504b). In this case, a network entity (not shown) sends a PDCCH order to a UE (not shown) via a DCI in a slot 1506. However, since the UE is only allowed to transmit RACH messages during RACH occasions, the UE must wait until RO 1504b to transmit a PRACH message in response to the PDCCH order.

The diagram 1508 illustrates a triggered RACH procedure that uses a PRACH offset to specify when a UE can transmit a triggered PRACH message. A network entity (not shown) sends a PDCCH order to a UE (not shown) via a DCI in a slot 1510. In this case, the UE transmits the PRACH message in response to the PDCCH order during a slot 1512 that follows the slot 1510 by a period of time 1514. In some examples, the period of time 1514 may be equal to or based on a PRACH offset that is sent to or preconfigured at the UE. Here, it may be seen that the PRACH message may be sent sooner in the example of diagram 1508 as compared to the example of diagram 1502.

The disclosure relates in some aspects to techniques for providing at least one transmission parameter to a UE, where the UE uses the at least one transmission parameter for communicating with a candidate cell. For example, in R18 L1/L2 mobility, when a UE is indicated to transmit only a PRACH of the RACH procedure for candidate cells, the UE may receive, in an active serving cell, further indications, such as TA, beam, or power control indications for the candidate cells.

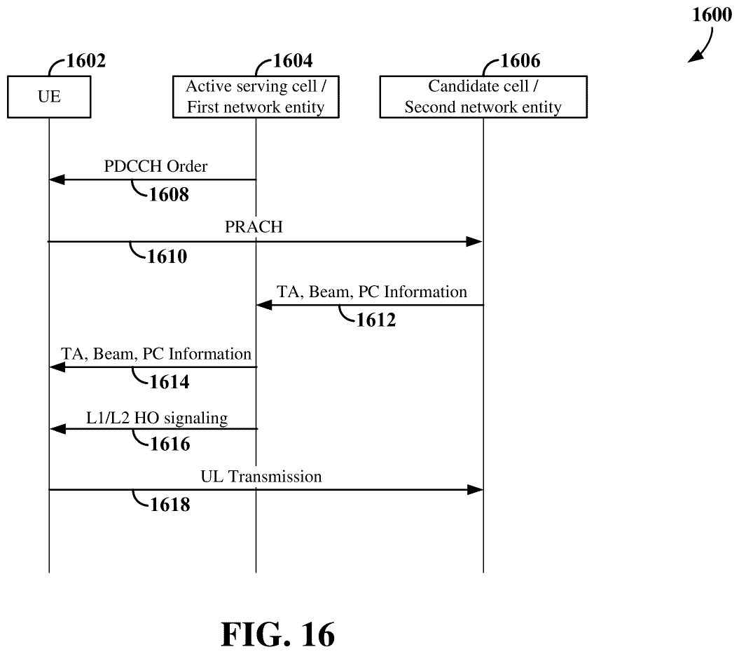

FIG. 16 is a signaling diagram 1600 illustrating an example of a triggered PRACH in a wireless communication system including a user equipment 1602, a first network entity 1604 (e.g., the active serving cell), and a second network entity 1606 (e.g., a candidate cell). In some examples, the user equipment 1602 may correspond to any of the UEs or scheduled entities shown in any of FIGS. 1-22. In some examples, the first network entity 1604 and the second network entity 1606 may correspond to any of the network entities, base stations, CUs, DUs, RUs, or scheduling entities shown in any of FIGS. 1-22.

At #1608 of FIG. 16, at some point in time (e.g., in preparation for handover of the user equipment 1602 to a candidate cell), the first network entity 1604 sends a PDCCH order to the user equipment 1602. In some examples, the PDCCH order instructs the user equipment to transmit a PRACH to at least one candidate cell (e.g., including a cell served by the second network entity 1606).

In some examples, the PDCCH order includes some or all of the PRACH information discussed at #1408 of FIG. 14. In some examples, the UE may have received some or all of this PRACH information in some other manner or the UE may have been preconfigured with some or all of this PRACH information.

At #1610, in response to the PDCCH order received at #1608, the user equipment 1602 transmits a PRACH to the second network entity 1606 (and, potentially, other network entities). Here, the user equipment 1602 may determine whether it is to transmit only the PRACH (and no other RACH messages) in response to the PDCCH order. For example, the user equipment 1602 may have received an indication (e.g., as discussed above) specifying that the user equipment 1602 is to transmit only the PRACH to a candidate cell served by the second network entity 1606 in response to the PDCCH order. As another example, there may be a defined rule (e.g., specified by a wireless communication standard, such as a 3GPP technical specification) that specifies that the user equipment 1602 is to transmit only the PRACH to a candidate cell (or certain candidate cells) in response to a PDCCH order.

As discussed above, the user equipment 1602 may transmit the PRACH based on PRACH information that was preconfigured in the user equipment 1602 and/or that the user equipment 1602 received from the first network entity 1604. For example, the user equipment 1602 may transmit the PRACH at a transmit power that is based on the PRACH power configuration information. As another example, the user equipment 1602 may repeatedly transmit the PRACH based on the PRACH repetition information. As a further example, the user equipment 1602 may transmit the PRACH at a time that is based on the PRACH offset information.

At #1612, the second network entity 1606 generates at least one transmission parameter based on the PRACH of #1610 and sends the at least one transmission parameter to the first network entity 1604. For example, the second network entity 1606 may determine timing advance information based on the PRACH and send this timing advance information to the first network entity 1604. As another example, the second network entity 1606 may determine beam information based on the PRACH and send this beam information to the first network entity 1604. As a further example, the second network entity 1606 may determine power control information based on the PRACH and send this power control information to the first network entity 1604.

At #1614, the first network entity 1604 sends at least one transmission parameter to the user equipment 1602. In some examples, the first network entity 1604 may forward the at least one transmission parameter received at #1612 to the user equipment 1602. In some examples, the first network entity 1604 may generate information based on the at least one transmission parameter received at #1612 and send this information to the user equipment 1602.

At some point in time (e.g., based on a measurement report received from the user equipment 1602 and/or based on the at least one transmission parameter received at #1614), the first network entity 1604 may elect to handover the user equipment to the second network entity 1606. Thus, at #1616, the first network entity 1604 sends a L1/L2 handover message to the user equipment 1602 to inform the user equipment 1602 that is it being handed-over to the second network entity 1606. In some aspects, this L1/L2 handover message may be referred to as including a cell switch command. In some examples, the L1/L2 handover message may be implemented using MAC-CE signaling. In some examples, the L1/L2 handover message may be implemented using DCI signaling.

At #1618, upon receiving the L1/L2 handover message, the user equipment 1602 sends an uplink transmission to the second network entity 1606. For example, the user equipment may transmit an L1/L2 handover complete message to the second network entity 1606 as discussed above.

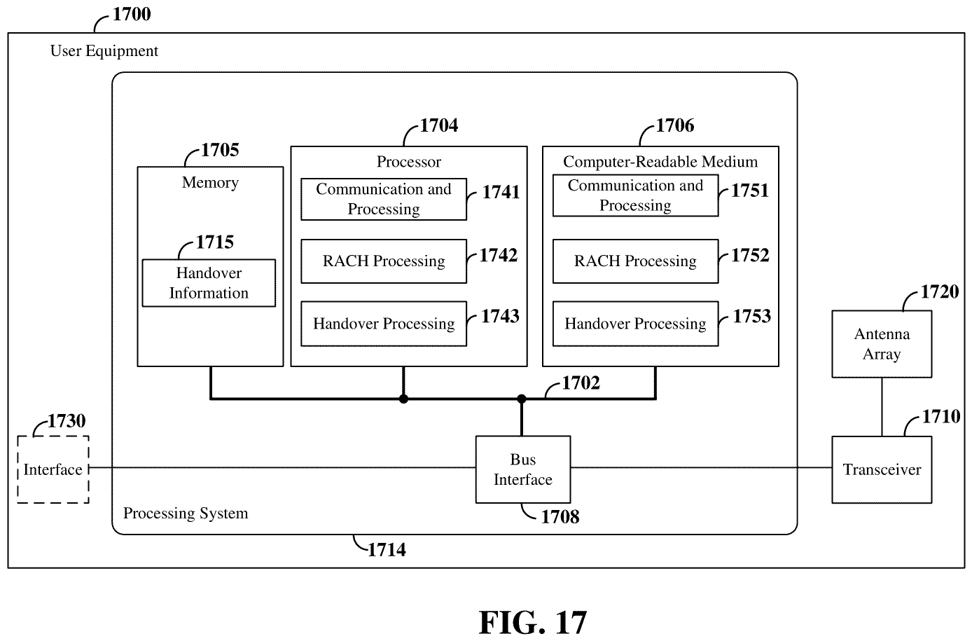

FIG. 17 is a block diagram illustrating an example of a hardware implementation for a UE 1700 employing a processing system 1714. For example, the UE 1700 may be a device configured to wirelessly communicate with a network entity, as discussed in any one or more of FIGS. 1-16. In some implementations, the UE 1700 may correspond to any of the UEs or scheduled entities shown in any of FIGS. 1-22.

In accordance with various aspects of the disclosure, an element, or any portion of an element, or any combination of elements may be implemented with the processing system 1714. The processing system 1714 may include one or more processors 1704. Examples of processors 1704 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. In various examples, the UE 1700 may be configured to perform any one or more of the functions described herein. That is, the processor 1704, as utilized in a UE 1700, may be used to implement any one or more of the processes and procedures described herein.

The processor 1704 may in some instances be implemented via a baseband or modem chip and in other implementations, the processor 1704 may include a number of devices distinct and different from a baseband or modem chip (e.g., in such scenarios as may work in concert to achieve the examples discussed herein). And as mentioned above, various hardware arrangements and components outside of a baseband modem processor can be used in implementations, including RF-chains, power amplifiers, modulators, buffers, interleavers, adders/summers, etc.

In this example, the processing system 1714 may be implemented with a bus architecture, represented generally by the bus 1702. The bus 1702 may include any number of interconnecting buses and bridges depending on the specific application of the processing system 1714 and the overall design constraints. The bus 1702 communicatively couples together various circuits including one or more processors (represented generally by the processor 1704), a memory 1705, and computer-readable media (represented generally by the computer-readable medium 1706). The bus 1702 may also link various other circuits such as timing sources, peripherals, voltage regulators, and power management circuits, which are well known in the art, and therefore, will not be described any further. A bus interface 1708 provides an interface between the bus 1702, a transceiver 1710 and an antenna array 1720 and between the bus 1702 and an interface 1730. The transceiver 1710 provides a communication interface or means for communicating with various other apparatus over a wireless transmission medium. The interface 1730 provides a communication interface or means of communicating with various other apparatuses and devices (e.g., other devices housed within the same apparatus as the UE 1700 or other external apparatuses) over an internal bus or external transmission medium, such as an Ethernet cable. Depending upon the nature of the apparatus, the interface 1730 may include a user interface (e.g., keypad, display, speaker, microphone, joystick). Of course, such a user interface is optional, and may be omitted in some examples, such as an IoT device.

The processor 1704 is responsible for managing the bus 1702 and general processing, including the execution of software stored on the computer-readable medium 1706. The software, when executed by the processor 1704, causes the processing system 1714 to perform the various functions described below for any particular apparatus. The computer-readable medium 1706 and the memory 1705 may also be used for storing data that is manipulated by the processor 1704 when executing software. For example, the memory 1705 may store handover information 1715 (e.g., measurement information) used by the processor 1704 for the communication operations described herein.

One or more processors 1704 in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium 1706.

The computer-readable medium 1706 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium 1706 may reside in the processing system 1714, external to the processing system 1714, or distributed across multiple entities including the processing system 1714. The computer-readable medium 1706 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

The UE 1700 may be configured to perform any one or more of the operations described herein (e.g., as described above in conjunction with FIGS. 1-16 and as described below in conjunction with FIGS. 17 and 18). In some aspects of the disclosure, the processor 1704, as utilized in the UE 1700, may include circuitry configured for various functions.

The processor 1704 may include communication and processing circuitry 1741. The communication and processing circuitry 1741 may be configured to communicate with a network entity, such as a gNB. The communication and processing circuitry 1741 may be configured to communicate with a base station and one or more other wireless communication devices over a common carrier shared between a cellular (e.g., Uu) interface and a sidelink (e.g., PC5) interface. The communication and processing circuitry 1741 may include one or more hardware components that provide the physical structure that performs various processes related to wireless communication (e.g., signal reception and/or signal transmission) as described herein. The communication and processing circuitry 1741 may further include one or more hardware components that provide the physical structure that performs various processes related to signal processing (e.g., processing a received signal and/or processing a signal for transmission) as described herein. In some examples, the communication and processing circuitry 1741 may include two or more transmit/receive chains (e.g., one chain to communicate with a base station and another chain to communicate with a sidelink device). The communication and processing circuitry 1741 may further be configured to execute communication and processing software 1751 included on the computer-readable medium 1706 to implement one or more functions described herein.

In some implementations where the communication involves receiving information, the communication and processing circuitry 1741 may obtain information from a component of the UE 1700 (e.g., from the transceiver 1710 that receives the information via radio frequency signaling or some other type of signaling suitable for the applicable communication medium), process (e.g., decode) the information, and output the processed information. For example, the communication and processing circuitry 1741 may output the information to another component of the processor 1704, to the memory 1705, or to the bus interface 1708. In some examples, the communication and processing circuitry 1741 may receive one or more of signals, messages, other information, or any combination thereof. In some examples, the communication and processing circuitry 1741 may receive information via one or more channels. In some examples, the communication and processing circuitry 1741 may receive one or more of signals, messages, SCIs, feedback, other information, or any combination thereof. In some examples, the communication and processing circuitry 1741 may receive information via one or more of a PSCCH, a PSSCH, a PSFCH, some other type of channel, or any combination thereof. In some examples, the communication and processing circuitry 1741 may include functionality for a means for receiving. In some examples, the communication and processing circuitry 1741 may include functionality for a means for decoding.

In some implementations where the communication involves sending (e.g., transmitting) information, the communication and processing circuitry 1741 may obtain information (e.g., from another component of the processor 1704, the memory 1705, or the bus interface 1708), process (e.g., encode) the information, and output the processed information. For example, the communication and processing circuitry 1741 may output the information to the transceiver 1710 (e.g., that transmits the information via radio frequency signaling or some other type of signaling suitable for the applicable communication medium). In some examples, the communication and processing circuitry 1741 may send one or more of signals, messages, other information, or any combination thereof. In some examples, the communication and processing circuitry 1741 may send information via one or more channels. In some examples, the communication and processing circuitry 1741 may send one or more of signals, messages, SCIs, feedback, other information, or any combination thereof. In some examples, the communication and processing circuitry 1741 may send information via one or more of a PSCCH, a PSSCH, a PSFCH, some other type of channel, or any combination thereof. In some examples, the communication and processing circuitry 1741 may include functionality for a means for transmitting (e.g., transmitting an uplink transmission). In some examples, the communication and processing circuitry 1741 may include functionality for a means for encoding.

The processor 1704 may include RACH processing circuitry 1742 configured to perform RACH processing-related operations as discussed herein (e.g., one or more of the operations described above in conjunction with FIGS. 11-16). The RACH processing circuitry 1742 may be configured to execute RACH processing software 1752 included on the computer-readable medium 1706 to implement one or more functions described herein.

The RACH processing circuitry 1742 may include functionality for a means for receiving (e.g., as described above in conjunction with FIGS. 11-16). For example, the RACH processing circuitry 1742 may cooperate with the communication and processing circuitry 1741 to receive a message (e.g., a PDCCH order) from a network entity, where the message triggers the transmission of a PRACH. As another example, the RACH processing circuitry 1742 may cooperate with the communication and processing circuitry 1741 to receive an indication (e.g., in a PDCCH order, a MAC-CE, a DCI, etc.) from a network entity, where the indication specifies whether the UE 1700 is to transmit only a PRACH message (RACH Msg1) in response the PDCCH order. As another example, the RACH processing circuitry 1742 may cooperate with the communication and processing circuitry 1741 to receive a message (e.g., including PRACH power configuration information, PRACH repetition information, PRACH offset information,, etc.) from a network entity.

The RACH processing circuitry 1742 may include functionality for a means for transmitting (e.g., as described above in conjunction with FIGS. 11-16). For example, the RACH processing circuitry 1742 may cooperate with the communication and processing circuitry 1741 to transmit a PRACH message (RACH Msg1) to a candidate cell.

The processor 1704 may include handover processing circuitry 1743 configured to perform handover processing-related operations as discussed herein (e.g., one or more of the operations described above in conjunction with FIGS. 11-16). The handover processing circuitry 1743 may be configured to execute handover processing software 1753 included on the computer-readable medium 1706 to implement one or more functions described herein.

The handover processing circuitry 1743 may include functionality for a means for receiving (e.g., as described above in conjunction with FIGS. 11-16). For example, the handover processing circuitry 1743 may cooperate with the communication and processing circuitry 1741 to receive a measurement report configuration from a network entity (e.g., via RRC signaling). As another example, the handover processing circuitry 1743 may cooperate with the communication and processing circuitry 1741 to receive a message (e.g., including a configuration, at least one transmission parameter, etc.) from a network entity (e.g., via a PDSCH or a PDCCH). As a further example, the handover processing circuitry 1743 may cooperate with the communication and processing circuitry 1741 to receive a handover command from a network entity. As another example, the handover processing circuitry 1743 may cooperate with the communication and processing circuitry 1741 to receive a MAC-CE and/or DCI from a network entity.

The handover processing circuitry 1743 may include functionality for a means for measuring signals (e.g., as described above in conjunction with FIGS. 11-16). For example, the handover processing circuitry 1743 may cooperate with the communication and processing circuitry 1741 to measure (e.g., aperiodically measure and/or periodically measure) reference signals (e.g., SSB signals, a TRS, a CSI-RS, etc.) transmitted by a cell (e.g., an SCell). As another example, the handover processing circuitry 1743 may cooperate with the communication and processing circuitry 1741 to perform measurements. As a further example, the handover processing circuitry 1743 may cooperate with the communication and processing circuitry 1741 to acquire SSB information from an SSB signal. As another example, the handover processing circuitry 1743 may cooperate with the communication and processing circuitry 1741 to perform CSI-RS measurements.

The handover processing circuitry 1743 may include functionality for a means for generating a measurement report (e.g., as described above in conjunction with FIG. 11 16). For example, the handover processing circuitry 1743 may generate a measurement report based on CSI-RS measurements, SSB measurement, etc. The report may include, for example, reference signal received power (RSRP) metrics and/or other metrics.

The handover processing circuitry 1743 may include functionality for a means for transmitting (e.g., as described above in conjunction with FIGS. 11-16). For example, the handover processing circuitry 1743 may cooperate with the communication and processing circuitry 1741 to transmit (e.g., aperiodically transmit and/or periodically transmit) a measurement report to a network entity. As another example, the handover processing circuitry 1743 may cooperate with the communication and processing circuitry 1741 to transmit a message to a network entity (e.g., via a PUSCH or a PUCCH). As a further example, the handover processing circuitry 1743 may cooperate with the communication and processing circuitry 1741 to transmit capability information to a network entity.

The handover processing circuitry 1743 may include functionality for a means for receiving a message (e.g., as described above in conjunction with FIGS. 11-16). For example, the handover processing circuitry 1743 may cooperate with the communication and processing circuitry 1741 to receive a message (e.g., for a cell addition or a cell activation) from network entity on designated resources. As another example, the handover processing circuitry 1743 may cooperate with the communication and processing circuitry 1741 to receive a handover command (e.g., a cell switch command) from a network entity.

The handover processing circuitry 1743 may include functionality for a means for transmitting a message (e.g., as described above in conjunction with FIGS. 11-16). For example, the handover processing circuitry 1743 may cooperate with the communication and processing circuitry 1741 to transmit a message (e.g., a handover complete message) to a network entity on designated resources.

FIG. 18 is a flow chart illustrating an example method 1800 for wireless communication in accordance with some aspects of the present disclosure. As described below, some or all illustrated features may be omitted in a particular implementation within the scope of the present disclosure, and some illustrated features may not be required for implementation of all examples. In some examples, the method 1800 (method for wireless communication) may be carried out by the UE 1700 illustrated in FIG. 17. In some examples, the method 1800 may be carried out by any suitable apparatus or means for carrying out the functions or algorithm described below.

At block 1802, a user equipment may receive, from a serving cell, a physical downlink control channel (PDCCH) order that triggers the user equipment to transmit a physical random access channel (PRACH) message to a candidate cell. In some examples, the RACH processing circuitry 1742 together with the communication and processing circuitry 1741 and the transceiver 1710, shown and described in FIG. 17, may provide a means to receive, from a serving cell, a physical downlink control channel (PDCCH) order that triggers the user equipment to transmit a physical random access channel (PRACH) message to a candidate cell.

At block 1804, the user equipment may transmit the PRACH message to the candidate cell in response to the PDCCH order. In some examples, the RACH processing circuitry 1742 together with the communication and processing circuitry 1741 and the transceiver 1710, shown and described in FIG. 17, may provide a means to transmit the PRACH message to the candidate cell in response to the PDCCH order.

In some examples, the user equipment may receive, from the serving cell, a cell switch command via a first layer 1 message or via a first layer 2 message. In some examples, the cell switch command may identify the candidate cell for handover of the user equipment.

In some examples, the user equipment may transmit a handover complete message to the candidate cell in response to the cell switch command. In some examples, the handover complete message may be transmitted via a second layer 1 message or via a second layer 2 message.

In some examples, the PRACH message is for a measurement by the candidate cell relating to at least one of a timing advance value, beam information, or power control information.

In some examples, the user equipment may receive an indication specifying that the user equipment is to transmit only the PRACH message in response to the PDCCH order. In some examples, the user equipment may transmit only the PRACH message in response to the PDCCH order based on the indication.

In some examples, the indication indicates that the user equipment will not receive a random access channel (RACH) message in response to the PRACH message. In some examples, the PDCCH order may include the indication.

In some examples, the user equipment may receive a radio resource control (RRC) message that includes the indication. In some examples, the user equipment may receive a medium access control-control element (MAC-CE) that includes the indication. In some examples, the user equipment may receive downlink control information (DCI) that includes the indication.

In some examples, the PDCCH order may include at least one field that indicates whether the user equipment is to transmit only the PRACH message in response to the PDCCH order. In some examples, the at least one field may include a frequency domain resource allocation (FDRA) field. In some examples, the at least one field may include an uplink/supplemental uplink (UL/SUL) field.

In some examples, the at least one field may include a first field that indicates whether the PDCCH order includes an indication of whether the user equipment is to transmit only the PRACH message in response to the PDCCH order. n some examples, the at least one field may include a second field that carries the indication.

In some examples, the user equipment may transmit only the PRACH message in response to the PDCCH order, responsive to a defined rule specifying that the user equipment is to transmit only PRACH messages in response to PDCCH orders directed to at least one candidate cell. In some examples, the user equipment may transmit only the PRACH message in response to the PDCCH order, responsive to a defined rule specifying that the user equipment is to transmit only PRACH messages in response to PDCCH orders directed to at least one deactivated candidate cell.

In some examples, the user equipment may receive PRACH power configuration information. In some examples, the user equipment may transmit the PRACH message based on the PRACH power configuration information.

In some examples, the PDCCH order includes the PRACH power configuration information. In some examples, the user equipment may receive downlink control information that includes the PRACH power configuration information. In some examples, the user equipment may receive a medium access control-control element (MAC-CE) that includes the PRACH power configuration information.

In some examples, the user equipment may receive PRACH repetition information. In some examples, the user equipment may transmit the PRACH message based on the PRACH repetition information.

In some examples, the PRACH repetition information specifies a quantity of PRACH messages to be transmitted. In some examples, the PRACH repetition information specifies a PRACH transmission periodicity. In some examples, the PRACH repetition information specifies at least one PRACH transmit power. In some examples, the PRACH repetition information specifies at least one quantity of beams associated with PRACH transmissions. In some examples, the PRACH repetition information specifies a PRACH repetition activation command. In some examples, the PRACH repetition information specifies a PRACH repetition deactivation command.

In some examples, the PDCCH order includes the PRACH repetition information. In some examples, the user equipment may receive downlink control information that includes the PRACH repetition information. In some examples, the user equipment may receive a medium access control-control element (MAC-CE) that includes the PRACH repetition information.

In some examples, the user equipment may receive PRACH offset information that specifies a period of time between the PDCCH order and the PRACH message. In some examples, the user equipment may transmit the PRACH message based on the PRACH offset information.

In some examples, the PRACH offset information may include a first PRACH offset associated with at least one intra-frequency candidate cell. In some examples, the PRACH offset information may include a second PRACH offset associated with at least one inter-frequency candidate cell. In some examples, the PRACH offset information may include a third PRACH offset associated with at least one active candidate cell. In some examples, the PRACH offset information may include a fourth PRACH offset associated with at least one deactivated candidate cell.

In some examples, the PDCCH order includes the PRACH offset information. In some examples, the user equipment may receive downlink control information that includes the PRACH offset information. In some examples, the user equipment may receive a medium access control-control element (MAC-CE) that includes the PRACH offset information.

In some examples, the user equipment may receive at least one transmission parameter from the serving cell after transmitting the PRACH message. In some examples, the user equipment may transmit an uplink transmission to the candidate cell based on the at least one transmission parameter.

In some examples, the at least one transmission parameter may include timing advance information. In some examples, the at least one transmission parameter may include beam information. In some examples, the at least one transmission parameter may include power control information.

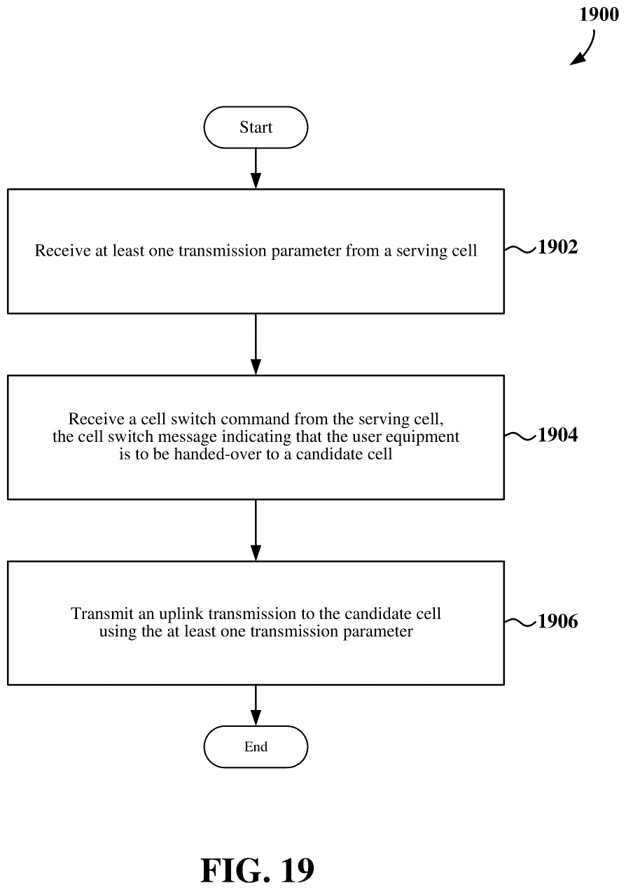

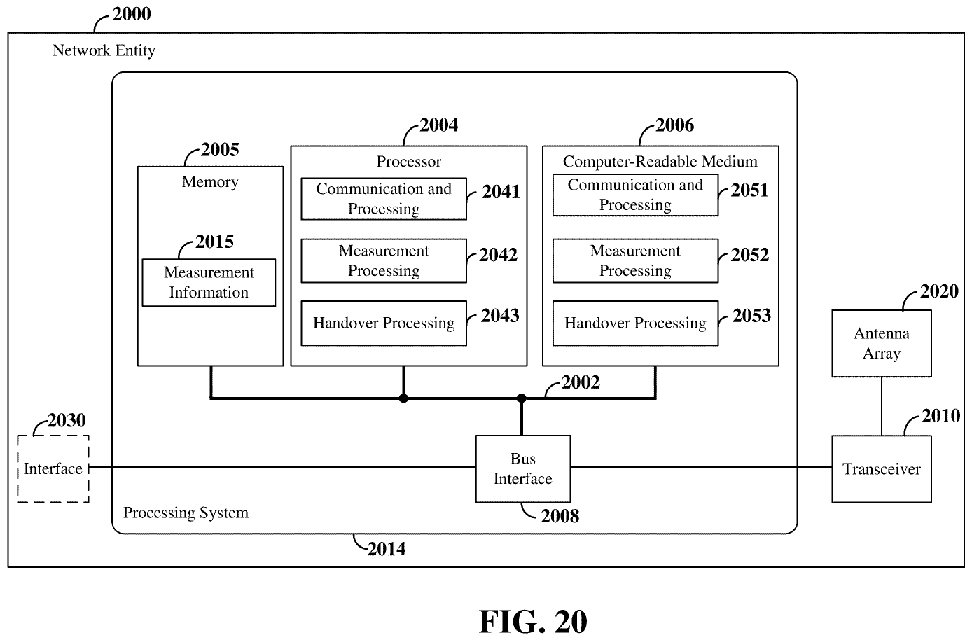

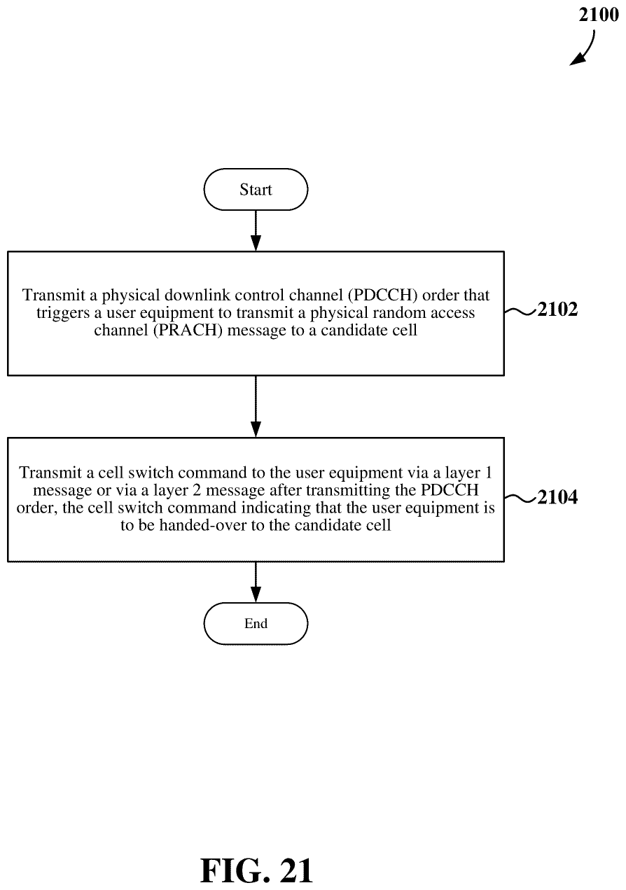

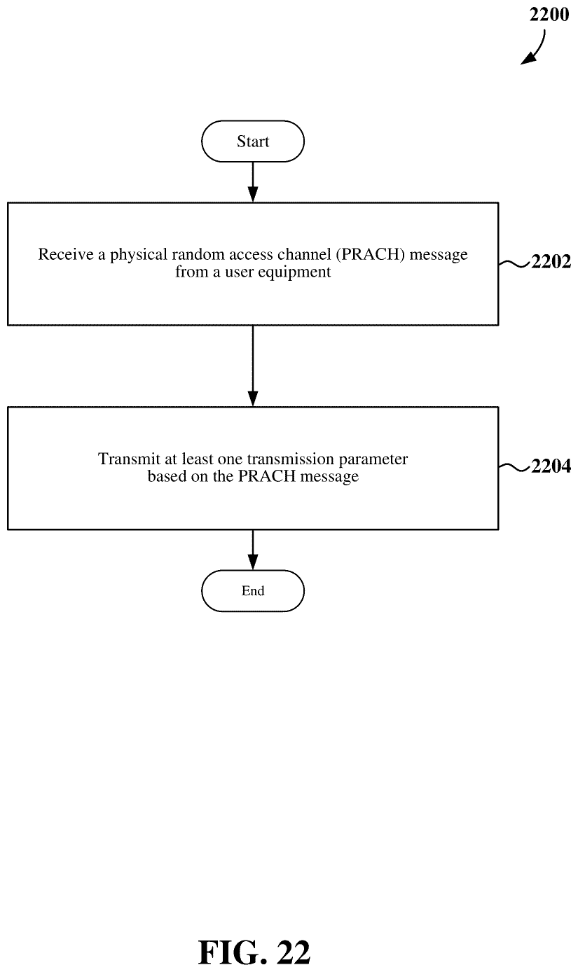

FIG. 19 is a flow chart illustrating an example method 1900 for wireless communication in accordance with some aspects of the present disclosure. As described below, some or all illustrated features may be omitted in a particular implementation within the scope of the present disclosure, and some illustrated features may not be required for implementation of all examples. In some examples, the method 1900 (method for wireless communication) may be carried out by the UE 1700 illustrated in FIG. 17. In some examples, the method 1900 may be carried out by any suitable apparatus or means for carrying out the functions or algorithm described below.

At block 1902, a user equipment may receive at least one transmission parameter from a serving cell. In some examples, the handover processing circuitry 1743 together with the communication and processing circuitry 1741 and the transceiver 1710, shown and described in FIG. 17, may provide a means to receive at least one transmission parameter from a serving cell.

At block 1904, the user equipment may receive a cell switch command from the serving cell, the cell switch message indicating that the user equipment is to be handed-over to a candidate cell. In some examples, the handover processing circuitry 1743 together with the communication and processing circuitry 1741 and the transceiver 1710, shown and described in FIG. 17, may provide a means to receive a cell switch command from the serving cell, the cell switch message indicating that the user equipment is to be handed-over to a candidate cell.

At block 1906, the user equipment may transmit an uplink transmission to the candidate cell using the at least one transmission parameter. In some examples, the handover processing circuitry 1743 together with the communication and processing circuitry 1741 and the transceiver 1710, shown and described in FIG. 17, may provide a means to transmit an uplink transmission to the candidate cell using the at least one transmission parameter.

In some examples, the user equipment may transmit a PRACH message to the candidate cell responsive to a PDCCH order. In some examples, the user equipment may receive the at least one transmission parameter after transmitting the PRACH message.

In some examples, the at least one transmission parameter may include timing advance information. In some examples, the at least one transmission parameter may include beam information. In some examples, the at least one transmission parameter may include power control information.

In some examples, the user equipment may transmit the uplink transmission using Layer 1 signaling and/or Layer 2 signaling. In some examples, the uplink transmission may include a handover complete message.

Referring again to FIG. 17, in one configuration, the UE 1700 includes means for receiving, from a serving cell, a physical downlink control channel (PDCCH) order that triggers the user equipment to transmit a physical random access channel (PRACH) message to a candidate cell, and means for transmitting the PRACH message to the candidate cell in response to the PDCCH order. In one configuration, the UE 1700 includes means for receiving at least one transmission parameter from a serving cell, means for receiving a cell switch command from the serving cell, the cell switch message indicating that the user equipment is to be handed-over to a candidate cell, and means for transmitting an uplink transmission to the candidate cell using the at least one transmission parameter. In one aspect, the aforementioned means may be the processor 1704 shown in FIG. 17 configured to perform the functions recited by the aforementioned means (e.g., as discussed above). In another aspect, the aforementioned means may be a circuit or any apparatus configured to perform the functions recited by the aforementioned means.

Of course, in the above examples, the circuitry included in the processor 1704 is merely provided as an example, and other means for carrying out the described functions may be included within various aspects of the present disclosure, including but not limited to the instructions stored in the computer-readable medium 1706, or any other suitable apparatus or means described in any one or more of FIGS. 1-3, 6-11, 13-15, and 17, and utilizing, for example, the methods and/or algorithms described herein in relation to FIGS. 18 and 19.

FIG. 20 is a conceptual diagram illustrating an example of a hardware implementation for a network entity 2000 employing a processing system 2014. In some implementations, the network entity 2000 may correspond to any of the base stations, CUs, DUs, RUs, or scheduling entities shown in any of FIGS. 1-22.

In accordance with various aspects of the disclosure, an element, or any portion of an element, or any combination of elements may be implemented with the processing system 2014. The processing system may include one or more processors 2004. The processing system 2014 may be substantially the same as the processing system 1714 illustrated in FIG. 17, including a bus interface 2008, a bus 2002, memory 2005, a processor 2004, a computer-readable medium 2006, a transceiver 2010, and an antenna array 2020. The memory 2005 may store handover information 2015 (e.g., measurement information) used by the processor 2004 in cooperation with the transceiver 2010 for communication operations as described herein. Furthermore, the network entity 2000 may include an interface 2030 (e.g., a network interface) that provides a means for communicating with at least one other apparatus within a core network and with at least one radio access network.

The network entity 2000 may be configured to perform any one or more of the operations described herein (e.g., as described above in conjunction with FIGS. 1-16 and as described below in conjunction with FIGS. 21 and 22). In some aspects of the disclosure, the processor 2004, as utilized in the network entity 2000, may include circuitry configured for various functions.

The processor 2004 may be configured to generate, schedule, and modify a resource assignment or grant of time-frequency resources (e.g., a set of one or more resource elements). For example, the processor 2004 may schedule time-frequency resources within a plurality of time division duplex (TDD) and/or frequency division duplex (FDD) subframes, slots, and/or mini-slots to carry user data traffic and/or control information to and/or from multiple scheduled entities. The processor 2004 may be configured to schedule resources for the transmission of downlink signals. The processor 2004 may further be configured to schedule resources for the transmission of uplink signals.

In some aspects of the disclosure, the processor 2004 may include communication and processing circuitry 2041. The communication and processing circuitry 2041 may be configured to communicate with a user equipment. The communication and processing circuitry 2041 may include one or more hardware components that provide the physical structure that performs various processes related to communication (e.g., signal reception and/or signal transmission) as described herein. The communication and processing circuitry 2041 may further include one or more hardware components that provide the physical structure that performs various processes related to signal processing (e.g., processing a received signal and/or processing a signal for transmission) as described herein. The communication and processing circuitry 2041 may further be configured to execute communication and processing software 2051 included on the computer-readable medium 2006 to implement one or more functions described herein.

The communication and processing circuitry 2041 may further be configured to receive an indication from the UE. For example, the indication may be included in a MAC-CE carried in a Uu PUSCH or a PSCCH, or included in a Uu RRC message or an SL RRC message, or included in a dedicated Uu PUCCH or PUSCH. The communication and processing circuitry 2041 may further be configured to receive a scheduling request from a UE for an uplink grant or a sidelink grant.

In some implementations wherein the communication involves receiving information, the communication and processing circuitry 2041 may obtain information from a component of the network entity 2000 (e.g., from the transceiver 2010 that receives the information via radio frequency signaling or some other type of signaling suitable for the applicable communication medium), process (e.g., decode) the information, and output the processed information. For example, the communication and processing circuitry 2041 may output the information to another component of the processor 2004, to the memory 2005, or to the bus interface 2008. In some examples, the communication and processing circuitry 2041 may receive one or more of signals, messages, other information, or any combination thereof. In some examples, the communication and processing circuitry 2041 may receive information via one or more channels. In some examples, the communication and processing circuitry 2041 may include functionality for a means for receiving (e.g., receiving an uplink transmission). In some examples, the communication and processing circuitry 2041 may include functionality for a means for decoding.

In some implementations wherein the communication involves sending (e.g., transmitting) information, the communication and processing circuitry 2041 may obtain information (e.g., from another component of the processor 2004, the memory 2005, or the bus interface 2008), process (e.g., encode) the information, and output the processed information. For example, the communication and processing circuitry 2041 may output the information to the transceiver 2010 (e.g., that transmits the information via radio frequency signaling or some other type of signaling suitable for the applicable communication medium). In some examples, the communication and processing circuitry 2041 may send one or more of signals, messages, other information, or any combination thereof. In some examples, the communication and processing circuitry 2041 may send information via one or more channels. In some examples, the communication and processing circuitry 2041 may include functionality for a means for transmitting. In some examples, the communication and processing circuitry 2041 may include functionality for a means for encoding.

The processor 2004 may include measurement processing circuitry 2042 configured to perform measurement processing-related operations as discussed herein (e.g., one or more of the operations described above in conjunction with FIGS. 11-16). The measurement processing circuitry 2042 may be configured to execute measurement processing software 2052 included on the computer-readable medium 2006 to implement one or more functions described herein.

The measurement processing circuitry 2042 may include functionality for a means for transmitting (e.g., as described above in conjunction with FIGS. 11-16). For example, the measurement processing circuitry 2042 may cooperate with the communication and processing circuitry 2041 to transmit a measurement report configuration to a UE (e.g., via RRC signaling). As another example, the measurement processing circuitry 2042 may cooperate with the communication and processing circuitry 2041 to transmit a message to a UE (e.g., via a PDSCH or a PDCCH). As a further example, the measurement processing circuitry 2042 may cooperate with the communication and processing circuitry 2041 to transmit a handover command to a UE. As another example, the measurement processing circuitry 2042 may cooperate with the communication and processing circuitry 2041 to transmit a MAC-CE and/or DCI to a UE. As another example, the measurement processing circuitry 2042 may cooperate with the communication and processing circuitry 2041 to transmit a configuration to a UE.

The measurement processing circuitry 2042 may include functionality for a means for receiving (e.g., as described above in conjunction with FIGS. 11-16). For example, the measurement processing circuitry 2042 may cooperate with the communication and processing circuitry 2041 to receive (e.g., aperiodically receive and/or periodically receive) a measurement report from a UE. For example, the measurement processing circuitry 2042 may receive, from a UE, a measurement report based on RSRP measurements and/or CSI-RS measurements. As another example, the measurement processing circuitry 2042 may cooperate with the communication and processing circuitry 2041 to receive a message from a UE (e.g., via a PUSCH or a PUCCH). As a further example, the measurement processing circuitry 2042 may cooperate with the communication and processing circuitry 2041 to receive capability information from a UE.

The processor 2004 may include handover processing circuitry 2043 configured to perform handover processing-related operations as discussed herein (e.g., one or more of the operations described above in conjunction with FIGS. 11-16). The handover processing circuitry 2043 may be configured to execute handover processing software 2053 included on the computer-readable medium 2006 to implement one or more functions described herein.

The handover processing circuitry 2043 may include functionality for a means for transmitting a message (e.g., as described above in conjunction with FIGS. 11-16). For example, the handover processing circuitry 2043 may cooperate with the communication and processing circuitry 2041 to transmit a message for a cell addition or a cell activation to a UE on designated resources. As another example, the handover processing circuitry 2043 may cooperate with the communication and processing circuitry 2041 to transmit a handover command (e.g., a cell switch command) to a user equipment. As yet another example, the handover processing circuitry 2043 may cooperate with the communication and processing circuitry 1741 to transmit a PDCCH order to a UE, where the message triggers the transmission of a PRACH. As a further example, the handover processing circuitry 2043 may cooperate with the communication and processing circuitry 1741 to transmit an indication (e.g., in a PDCCH order, a MAC-CE, a DCI, etc.) to a UE, where the indication specifies whether the UE is to transmit only a PRACH message (RACH Msg1) in response the PDCCH order. Also, the handover processing circuitry 2043 may cooperate with the communication and processing circuitry 1741 to transmit a message (e.g., including PRACH power configuration information, PRACH repetition information, PRACH offset information,, etc.) to a UE.

The handover processing circuitry 2043 may include functionality for a means for receiving a message (e.g., as described above in conjunction with FIGS. 11-16) . For example, the handover processing circuitry 2043 may cooperate with the communication and processing circuitry 2041 to receive a message from a UE on designated resources. As another example, the handover processing circuitry 2043 may cooperate with the communication and processing circuitry 2041 to receive a RACH message (e.g., a PRACH message) from a UE.

In some examples, the network entity 2000 shown and described above in connection with FIG. 20 may be a disaggregated base station. For example, the network entity 2000 shown in FIG. 20 may include the CU and optionally one or more DUs/RUs of the disaggregated base station. Other DUs/RUs associated with the network entity 2000 may be distributed throughout the network. In some examples, the DUs/RUs may correspond to TRPs associated with the network entity. In some examples, the CU and/or DU/RU of the disaggregated base station (e.g., within the network entity 2000) may generate handover information and provide the information to a user equipment, as well as receive and process messages from the user equipment.

FIG. 21 is a flow chart illustrating an example method 2100 for wireless communication in accordance with some aspects of the present disclosure. As described below, some or all illustrated features may be omitted in a particular implementation within the scope of the present disclosure, and some illustrated features may not be required for implementation of all examples. In some examples, the method 2100 may be carried out by the network entity 2000 illustrated in FIG. 20. In some examples, the method 2100 may be carried out by any suitable apparatus or means for carrying out the functions or algorithm described below.

At block 2102, a network entity may transmit a physical downlink control channel (PDCCH) order that triggers a user equipment to transmit a physical random access channel (PRACH) message to a candidate cell. In some examples, the handover processing circuitry 2043 together with the communication and processing circuitry 2041 and the transceiver 2010, shown and described in FIG. 20, may provide a means to transmit a physical downlink control channel (PDCCH) order that triggers a user equipment to transmit a physical random access channel (PRACH) message to a candidate cell.

At block 2104, the network entity may transmit a cell switch command to the user equipment via a layer 1 message or via a layer 2 message after transmitting the PDCCH order, the cell switch command indicating that the user equipment is to be handed-over to the candidate cell. In some examples, the handover processing circuitry 2043 together with the communication and processing circuitry 2041 and the transceiver 2010, shown and described in FIG. 20, may provide a means to transmit a cell switch command to the user equipment via a layer 1 message or via a layer 2 message after transmitting the PDCCH order, the cell switch command indicating that the user equipment is to be handed-over to the candidate cell.

In some examples, the PRACH message is for a measurement by the candidate cell relating to at least one of a timing advance value, beam information, or power control information.

In some examples, the network entity may transmit an indication to the user equipment. In some examples, the indication specifies that the user equipment is to transmit only the PRACH message in response the PDCCH order.

In some examples, the indication indicates that the user equipment will not receive a random access channel (RACH) message in response to the PRACH message. In some examples, the PDCCH order may include the indication.

In some examples, the network entity may transmit a radio resource control (RRC) message that includes the indication. In some examples, the network entity may transmit a medium access control-control element (MAC-CE) that includes the indication. In some examples, the network entity may transmit downlink control information (DCI) that includes the indication.

In some examples, the PDCCH order may include at least one field that indicates whether the user equipment is to transmit only the PRACH message in response to the PDCCH order. In some examples, the at least one field may include a frequency domain resource allocation (FDRA) field. In some examples, the at least one field may include an uplink/supplemental uplink (UL/SUL) field.

In some examples, the at least one field may include a first field that indicates whether the PDCCH order includes an indication of whether the user equipment is to transmit only the PRACH message in response to the PDCCH order. n some examples, the at least one field may include a second field that carries the indication.

In some examples, the network entity may transmit PRACH power configuration information. In some examples, the PDCCH order includes the PRACH power configuration information. In some examples, the network entity may transmit downlink control information that includes the PRACH power configuration information. In some examples, the network entity may transmit a medium access control-control element (MAC-CE) that includes the PRACH power configuration information.

In some examples, the network entity may transmit PRACH repetition information. In some examples, the PRACH repetition information specifies a quantity of PRACH messages to be transmitted. In some examples, the PRACH repetition information specifies a PRACH transmission periodicity. In some examples, the PRACH repetition information specifies at least one PRACH transmit power. In some examples, the PRACH repetition information specifies at least one quantity of beams associated with PRACH transmissions. In some examples, the PRACH repetition information specifies a PRACH repetition activation command. In some examples, the PRACH repetition information specifies a PRACH repetition deactivation command.

In some examples, the PDCCH order includes the PRACH repetition information. In some examples, the network entity may transmit downlink control information that includes the PRACH repetition information. In some examples, the network entity may transmit a medium access control-control element (MAC-CE) that includes the PRACH repetition information.

In some examples, the network entity may transmit PRACH offset information that specifies a period of time between the PDCCH order and the PRACH message. In some examples, the PRACH offset information may include a first PRACH offset associated with at least one intra-frequency candidate cell. In some examples, the PRACH offset information may include a second PRACH offset associated with at least one inter-frequency candidate cell. In some examples, the PRACH offset information may include a third PRACH offset associated with at least one active candidate cell. In some examples, the PRACH offset information may include a fourth PRACH offset associated with at least one deactivated candidate cell.

In some examples, the PDCCH order includes the PRACH offset information. In some examples, the network entity may transmit downlink control information that includes the PRACH offset information. In some examples, the network entity may transmit a medium access control-control element (MAC-CE) that includes the PRACH offset information.

In some examples, the network entity may receive at least one transmission parameter from a candidate cell after the user equipment transmits the PRACH message. In some examples, the network entity may forward the at least one transmission parameter to the user equipment.

In some examples, the at least one transmission parameter may include timing advance information. In some examples, the at least one transmission parameter may include beam information. In some examples, the at least one transmission parameter may include power control information.

FIG. 22 is a flow chart illustrating an example method 2200 for wireless communication in accordance with some aspects of the present disclosure. As described below, some or all illustrated features may be omitted in a particular implementation within the scope of the present disclosure, and some illustrated features may not be required for implementation of all examples. In some examples, the method 2200 may be carried out by the network entity 2000 illustrated in FIG. 20. In some examples, the method 2200 may be carried out by any suitable apparatus or means for carrying out the functions or algorithm described below.

At block 2202, a network entity may receive a physical random access channel (PRACH) message from a user equipment. In some examples, the measurement processing circuitry 1942 together with the communication and processing circuitry 1941 and the transceiver 1910, shown and described in FIG. 19, may provide a means to receive a physical random access channel (PRACH) message from a user equipment.

At block 2204, the network entity may transmit at least one transmission parameter based on the PRACH message. In some examples, the measurement processing circuitry 1942 together with the communication and processing circuitry 1941 and the transceiver 1910, shown and described in FIG. 19, may provide a means to transmit at least one transmission parameter based on the PRACH message.

In some examples, the network entity may refrain from transmitting a response to the PRACH message. In some examples, the network entity may refrain from transmitting a response to the PRACH message, responsive to a cell to which the PRACH was transmitted being a candidate cell for the user equipment. In some examples, the network entity may refrain from transmitting a response to the PRACH message, responsive to a cell to which the PRACH was transmitted being deactivated.

In some examples, the PRACH message is for a measurement by the candidate cell relating to at least one of a timing advance value, beam information, or power control information.

In some examples, the at least one transmission parameter may include timing advance information. In some examples, the at least one transmission parameter may include beam information. In some examples, the at least one transmission parameter may include power control information.

In some examples, the network entity may receive an uplink transmission transmitted via Layer 1 signaling and/or Layer 2 signaling from the user equipment. In some examples, the uplink transmission may include a handover complete message.

Referring again to FIG. 20, in one configuration, the network entity 2000 includes means for transmitting a physical downlink control channel (PDCCH) order that triggers a user equipment to transmit a physical random access channel (PRACH) message to a candidate cell, and means for transmitting a cell switch command to the user equipment via a layer 1 message or via a layer 2 message after transmitting the PDCCH order, the cell switch command indicating that the user equipment is to be handed-over to the candidate cell. In one configuration, the network entity 2000 includes means for receiving a physical random access channel (PRACH) message from a user equipment, and means for transmitting at least one transmission parameter based on the PRACH message. In one aspect, the aforementioned means may be the processor 2004 shown in FIG. 20 configured to perform the functions recited by the aforementioned means (e.g., as discussed above). In another aspect, the aforementioned means may be a circuit or any apparatus configured to perform the functions recited by the aforementioned means.

Of course, in the above examples, the circuitry included in the processor 2004 is merely provided as an example, and other means for carrying out the described functions may be included within various aspects of the present disclosure, including but not limited to the instructions stored in the computer-readable medium 2006, or any other suitable apparatus or means described in any one or more of FIGS. 1-3, 6-11, 13-15, and 20, and utilizing, for example, the methods and/or algorithms described herein in relation to FIGS. 21 and 22.

The methods shown in FIGS. 18, 19, 21, and 22 may include additional aspects, such as any single aspect or any combination of aspects described below and/or in connection with one or more other processes described elsewhere herein. The following provides an overview of several aspects of the present disclosure.

Aspect 1: A method for wireless communication at a user equipment, the method comprising: receiving, from a serving cell, a physical downlink control channel (PDCCH) order that triggers the user equipment to transmit a physical random access channel (PRACH) message to a candidate cell; and transmitting the PRACH message to the candidate cell in response to the PDCCH order.

Aspect 2: The method of aspect 1, further comprising: receiving, from the serving cell, a cell switch command via a first layer 1 message or via a first layer 2 message, the cell switch command identifying the candidate cell for handover of the user equipment; and transmitting a handover complete message to the candidate cell in response to the cell switch command, the handover complete message being transmitted via a second layer 1 message or via a second layer 2 message.

Aspect 3: The method of aspects 1 through 2, wherein the PRACH message is for a measurement by the candidate cell relating to at least one of: a timing advance value, beam information, or power control information.

Aspect 4: The method of any of aspects 1 through 3, further comprising: receiving an indication specifying that the user equipment is to transmit only the PRACH message in response to the PDCCH order, wherein the transmitting the PRACH message comprises only transmitting the PRACH message in response to the PDCCH order based on the indication.

Aspect 5: The method of aspect 4, wherein the indication indicates that the user equipment will not receive a random access channel (RACH) message in response to the PRACH message.

Aspect 6: The method of any of aspects 4 through 5, wherein the PDCCH order comprises the indication.

Aspect 7: The method of any of aspects 4 through 5, wherein the receiving the indication comprises: receiving a radio resource control (RRC) message that includes the indication; receiving a medium access control-control element (MAC-CE) that includes the indication; or receiving downlink control information (DCI) that includes the indication.

Aspect 8: The method of any of aspects 1 through 6, wherein the PDCCH order comprises at least one field that indicates whether the user equipment is to transmit only the PRACH message in response to the PDCCH order.

Aspect 9: The method of aspect 8, wherein the at least one field comprises a frequency domain resource allocation (FDRA) field.

Aspect 10: The method of any of aspects 8 through 9, wherein the at least one field comprises an uplink/supplemental uplink (UL/SUL) field.

Aspect 11: The method of any of aspects 8 through 10, wherein the at least one field comprises: a first field that indicates whether the PDCCH order includes an indication of whether the user equipment is to transmit only the PRACH message in response to the PDCCH order; and a second field that carries the indication.

Aspect 12: The method of any of aspects 1 through 3, wherein the transmitting the PRACH message comprises: transmitting only the PRACH message in response to the PDCCH order, responsive to a defined rule specifying that the user equipment is to transmit only PRACH messages in response to PDCCH orders directed to at least one candidate cell.

Aspect 13: The method of any of aspects 1 through 3, wherein the transmitting the PRACH message comprises: transmitting only the PRACH message in response to the PDCCH order, responsive to a defined rule specifying that the user equipment is to transmit only PRACH messages in response to PDCCH orders directed to at least one deactivated candidate cell.

Aspect 14: The method of any of aspects 1 through 13, further comprising: receiving PRACH power configuration information, wherein the transmitting the PRACH message comprises transmitting the PRACH message based on the PRACH power configuration information.

Aspect 15: The method of aspect 14, wherein: the PDCCH order includes the PRACH power configuration information; the receiving the PRACH power configuration information comprises receiving downlink control information that includes the PRACH power configuration information; or the receiving the PRACH power configuration information comprises receiving a medium access control-control element (MAC-CE) that includes the PRACH power configuration information.

Aspect 16: The method of any of aspects 1 through 15, further comprising: receiving PRACH repetition information, wherein the transmitting the PRACH message comprises transmitting the PRACH message based on the PRACH repetition information.

Aspect 17: The method of aspect 16, wherein the PRACH repetition information specifies at least one of: a quantity of PRACH messages to be transmitted; a PRACH transmission periodicity; at least one PRACH transmit power; at least one quantity of beams associated with PRACH transmissions; a PRACH repetition activation command; or a PRACH repetition deactivation command.

Aspect 18: The method of any of aspects 16 through 17, wherein: the PDCCH order includes the PRACH repetition information; the receiving the PRACH repetition information comprises receiving downlink control information that includes the PRACH repetition information; or the receiving the PRACH repetition information comprises receiving a medium access control-control element (MAC-CE) that includes the PRACH repetition information.

Aspect 19: The method of any of aspects 1 through 18, further comprising: receiving PRACH offset information that specifies a period of time between the PDCCH order and the PRACH message, wherein the transmitting the PRACH message comprises transmitting the PRACH message based on the PRACH offset information.

Aspect 20: The method of aspect 19, wherein the PRACH offset information comprises at least one of: a first PRACH offset associated with at least one intra-frequency candidate cell; a second PRACH offset associated with at least one inter-frequency candidate cell; a third PRACH offset associated with at least one active candidate cell; or a fourth PRACH offset associated with at least one deactivated candidate cell.

Aspect 21: The method of any of aspects 19 through 20, wherein: the PDCCH order includes the PRACH offset information; the receiving the PRACH offset information comprises receiving downlink control information that includes the PRACH offset information; or the receiving the PRACH offset information comprises receiving a medium access control-control element (MAC-CE) that includes the PRACH offset information.

Aspect 22: The method of any of aspects 1 through 21, further comprising: receiving at least one transmission parameter from the serving cell after transmitting the PRACH message; and transmitting an uplink transmission to the candidate cell based on the at least one transmission parameter.

Aspect 23: The method of aspect 22, wherein the at least one transmission parameter comprises at least one of: timing advance information; beam information; or power control information.

Aspect 25: A method for wireless communication at a network entity, the method comprising: transmitting a physical downlink control channel (PDCCH) order that triggers a user equipment to transmit a physical random access channel (PRACH) message to a candidate cell; and transmitting a cell switch command to the user equipment via a layer 1 message or via a layer 2 message after transmitting the PDCCH order, the cell switch command indicating that the user equipment is to be handed-over to the candidate cell.

Aspect 26: The method of aspect 25, further comprising: transmitting an indication to the user equipment, wherein the indication specifies that the user equipment is to transmit only the PRACH message in response the PDCCH order.

Aspect 27: The method of any of aspects 25 through 26, further comprising: transmitting PRACH power configuration information for the PRACH message to the user equipment.

Aspect 28: The method of any of aspects 25 through 27, further comprising: transmitting PRACH repetition information for the PRACH message to the user equipment.

Aspect 29: The method of any of aspects 25 through 28, further comprising: transmitting PRACH offset information for the PRACH message to the user equipment.

Aspect 30: A user equipment comprising: a transceiver configured to communicate with a radio access network, a memory, and a processor coupled to the transceiver and the memory, wherein the processor and the memory are configured to perform any one or more of aspects 1 through 23.

Aspect 31: An apparatus configured for wireless communication comprising at least one means for performing any one or more of aspects 1 through 23.

Aspect 32: A non-transitory computer-readable medium storing computer-executable code, comprising code for causing an apparatus to perform any one or more of aspects 1 through 23.

Aspect 33: A network entity comprising: a transceiver, a memory, and a processor coupled to the transceiver and the memory, wherein the processor and the memory are configured to perform any one or more of aspects 25 through 29.

Aspect 34: An apparatus configured for wireless communication comprising at least one means for performing any one or more of aspects 25 through 29.

Aspect 35: A non-transitory computer-readable medium storing computer-executable code, comprising code for causing an apparatus to perform any one or more of aspects 25 through 29.

Several aspects of a wireless communication network have been presented with reference to an example implementation. As those skilled in the art will readily appreciate, various aspects described throughout this disclosure may be extended to other telecommunication systems, network architectures and communication standards.

By way of example, various aspects may be implemented within other systems defined by 3GPP, such as Long-Term Evolution (LTE), the Evolved Packet System (EPS), the Universal Mobile Telecommunication System (UMTS), and/or the Global System for Mobile (GSM). Various aspects may also be extended to systems defined by the 3rd Generation Partnership Project 2 (3GPP2), such as CDMA 2000 and/or Evolution-Data Optimized (EV-DO). Other examples may be implemented within systems employing Institute of Electrical and Electronics Engineers (IEEE) 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another-even if they do not directly physically touch each other. For instance, a first object may be coupled to a second object even though the first object is never directly physically in contact with the second object. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure. As used herein, the term “determining” may include, for example, ascertaining, resolving, selecting, choosing, establishing, calculating, computing, processing, deriving, investigating, looking up (e.g., looking up in a table, a database or another data structure), and the like. Also, “determining” may include receiving (e.g., receiving information), accessing (e.g., accessing data in a memory), and the like.

One or more of the components, steps, features and/or functions illustrated in FIGS. 1-22 may be rearranged and/or combined into a single component, step, feature or function or embodied in several components, steps, or functions. Additional elements, components, steps, and/or functions may also be added without departing from novel features disclosed herein. The apparatus, devices, and/or components illustrated in FIGS. 1-22 may be configured to perform one or more of the methods, features, or steps escribed herein. The novel algorithms described herein may also be efficiently implemented in software and/or embedded in hardware.

It is to be understood that the specific order or hierarchy of steps in the methods disclosed is an illustration of example processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b, and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. A method for wireless communication at a user equipment, the method comprising:
receiving, from a serving cell, a physical downlink control channel (PDCCH) order that triggers the user equipment to transmit a physical random access channel (PRACH) message to a candidate cell; and
transmitting the PRACH message to the candidate cell in response to the PDCCH order.

2-23. (canceled)

24. A user equipment, comprising:
one or more transceivers
one or more memories; and
one or more processors coupled to the one or more transceivers and the one or more memories, wherein the one or more processors are configured to:
receive, from a serving cell, a physical downlink control channel (PDCCH) order that triggers the user equipment to transmit a physical random access channel (PRACH) message to a candidate cell; and
transmit the PRACH message to the candidate cell in response to the PDCCH order.

25-29. (canceled)

30. A network entity, comprising:
one or more transceivers
one or more memories; and
one or more processors coupled to the one or more transceivers and the one or more processors, wherein the one or more processors are configured to:
transmit a physical downlink control channel (PDCCH) order that triggers a user equipment to transmit a physical random access channel (PRACH) message to a candidate cell; and
transmit a cell switch command to the user equipment via a layer 1 message or via a layer 2 message after transmitting the PDCCH order, the cell switch command indicating that the user equipment is to be handed-over to the candidate cell.

31. The user equipment of claim 24, wherein the one or more processors are further configured to:
receive, from the serving cell, a cell switch command via a first layer 1 message or via a first layer 2 message, the cell switch command identifying the candidate cell for handover of the user equipment; and
transmit a handover complete message to the candidate cell in response to the cell switch command, the handover complete message being transmitted via a second layer 1 message or via a second layer 2 message.

32. The user equipment of claim 24, wherein the PRACH message is for a measurement by the candidate cell relating to at least one of: a timing advance value, beam information, or power control information.

33. The user equipment of claim 24:
wherein the one or more processors are further configured to receive an indication specifying that the user equipment is to transmit only the PRACH message in response to the PDCCH order; and
wherein, the one or more processors, when configured to transmit the PRACH message, are further configured to only transmit the PRACH message in response to the PDCCH order based on the indication.

34. The user equipment of claim 33, wherein the indication indicates that the user equipment will not receive a random access channel (RACH) message in response to the PRACH message.

35. The user equipment of claim 33, wherein the PDCCH order comprises the indication.

36. The user equipment of claim 33, wherein the one or more processors, when configured to receive the indication, are further configured to:
receive a radio resource control (RRC) message that includes the indication;
receive a medium access control-control element (MAC-CE) that includes the indication; or
receive downlink control information (DCI) that includes the indication.

37. The user equipment of claim 24, wherein the PDCCH order comprises at least one field that indicates whether the user equipment is to transmit only the PRACH message in response to the PDCCH order.

38. The user equipment of claim 37, wherein the at least one field comprises a frequency domain resource allocation (FDRA) field.

39. The user equipment of claim 37, wherein the at least one field comprises an uplink/supplemental uplink (UL/SUL) field.

40. The user equipment of claim 37, wherein the at least one field comprises:
a first field that indicates whether the PDCCH order includes an indication of whether the user equipment is to transmit only the PRACH message in response to the PDCCH order; and
a second field that carries the indication.

41. The user equipment of claim 24, wherein the one or more processors, when configured to transmit the PRACH message, are further configured:
transmit only the PRACH message in response to the PDCCH order, responsive to a defined rule specifying that the user equipment is to transmit only PRACH messages in response to PDCCH orders directed to at least one candidate cell.

42. The user equipment of claim 24, wherein the one or more processors, when configured to transmit the PRACH message, are further configured to:
transmit only the PRACH message in response to the PDCCH order, responsive to a defined rule specifying that the user equipment is to transmit only PRACH messages in response to PDCCH orders directed to at least one deactivated candidate cell.

43. The user equipment of claim 24:
wherein the one or more processors are further configured to receive PRACH power configuration information; and
wherein the one or more processors, when configured to transmit the PRACH message, are further configured to transmit the PRACH message based on the PRACH power configuration information.

44. The user equipment of claim 30, wherein the one or more processors are further configured to:
transmit an indication to the user equipment,
wherein the indication specifies that the user equipment is to transmit only the PRACH message in response the PDCCH order.

45. The user equipment of claim wherein the one or more processors are further configured to:
transmit PRACH power configuration information for the PRACH message to the user equipment.

46. The user equipment of claim 44, wherein the one or more processors are further configured to:
transmit PRACH repetition information for the PRACH message to the user equipment.

47. The user equipment of claim 44, wherein the one or more processors are further configured to:
transmit PRACH offset information for the PRACH message to the user equipment.
